(19) United States
(12) Patent Application Publication
(10) Pub. No.: US 2006/0050037 A1
(43) Pub. Date: Mar. 9, 2006

(54) Impedance conversion circuit, drive circuit, and control method of impedance conversion circuit

(76) Inventor: Katsuhiko Maki, Chino (JP)

Correspondence Address: HARNESS, DICKEY & PIERCE, P.L.C., P.O. BOX 828, BLOOMFIELD HILLS, MI, 48303, US

(21) Appl. No.: 11/218,353

(22) Filed: Sep. 2, 2005

(30) Foreign Application Priority Data
Sep. 3, 2004 (JP) 2004-257332

(51) Int. Cl. G09G 3/36

(52) U.S. Cl. 345/89

(57) ABSTRACT

An impedance conversion circuit IPC₁ including: an operational amplifier OP₁ connected as a voltage follower and supplied with, as an input voltage Vin, a voltage selected from 2^{j} levels of voltages (j is a positive integer) based on data of high j bits of the gray scale data; and an output voltage setting circuit OVS₁ for precharging or discharging an output of the operational amplifier OP₁ based on data of a most significant bit of low k bits (k is an integer more than 1) of the gray scale data. The operational amplifier OP₁ outputs, as an output voltage, a voltage having a difference from the input voltage by a dead zone width after the output voltage setting circuit OVS₁ precharges or discharges the output of the operational amplifier OP₁. The dead zone width is determined by an operating current of the operational amplifier OP₁. The operating current is varied based on data of low k bits of the gray scale data.

Japanese Patent Application No. 2004-257332, filed on Sep. 3, 2004, is hereby incorporated by reference in its entirety.

### BACKGROUND OF THE INVENTION

The present invention relates to an impedance conversion circuit, a drive circuit, and a control method for an impedance conversion circuit.

As liquid crystal panels (electro-optical devices, in a broad sense) of the related art used for electronic apparatuses such as mobile phones, simple matrix liquid crystal panels and active matrix liquid crystal panels that use switching elements such as thin film transistors (hereinafter abbreviated as TFT) have been known.

The simple matrix panels have an advantage of achieving low power consumption more easily compared with the active matrix panels while having a disadvantage of involving difficulties in displaying multi-colored images or movies. In contrast, the active matrix panels have an advantage of being suitable for displaying multi-colored images or movies while having a disadvantage of involving difficulties in achieving low power consumption.

In recent years, there have been increasing demands for portable electronic apparatuses such as mobile phones to display multi-colored images or movies in order to provide high quality images. Accordingly, the simple matrix liquid crystal panels used thus far have gradually been replaced with the active matrix liquid crystal panels.

In the active matrix liquid crystal panel, an impedance conversion circuit as an output buffer is preferably provided in a data driver (a drive circuit, in a broad sense) for driving data lines of the liquid crystal panel. The impedance conversion circuit includes an operational amplifier, and can stably supply voltages to the data lines with its high driving capability.

The impedance conversion circuit supplies gray scale voltages corresponding to gray scale data (data, in a broad sense) to the data lines. In this case, a gray scale voltage corresponding to the gray scale data is selected from pre-generated plural gray scale voltages, and the impedance conversion circuit to which the gray scale voltage has been input drives the data line.

The impedance conversion circuit thus driving the data line is provided for each of the data lines. Therefore, as shown in FIG. 28, the plural impedance conversion circuits are disposed along the arrangement direction of the data lines.

In the case of FIG. 28, a reference voltage generating circuit 800 generates plural gray scale voltages V0 through V63 corresponding to 6-bit gray scale data. The reference voltage generating circuit 800 divides a voltage between a system supply voltage VDD and a system ground supply voltage VSS with resistor elements to generate the plural gray scale voltages V0 through V63.

In order to supply the plural gray scale voltages V0 through V63 thus generated to the impedance conversion circuits, a group of gray scale voltage signal lines to which the plural gray scale voltages are supplied is disposed to extend along the arrangement direction of the data lines. An input of each impedance conversion circuit is electrically coupled to a respective one of the gray scale voltage signal lines corresponding to the gray scale data. An example of the related art is disclosed in Japanese Patent Application Laid-Open No. 2003-233354.

In order to improve the image display quality of liquid crystal panels, increasing the number of gray scales is required. The increase of the number of gray scales corresponds to increase of the number of levels of gray scale voltages. This increase of the voltage levels leads to increase of the number of gray scale voltage signal lines shown in FIG. 28. The larger number of gray scales, therefore, results in a larger wiring region width WD of the group of gray scale voltage signal lines of FIG. 28.

For example, the wiring region width WD for the case in which the gray scale data for one dot is composed of 6 bits (namely 64 gray scales) will be estimated below. In the case shown in FIG. 29B, for example, the gray scale voltage signal lines are disposed alternately on a first wiring layer and a second wiring layer to minimize the wiring capacity between the adjacent gray scale voltage signal lines. In this case, if the width of each signal line is 1.25 μm and the design rule distance between the signal lines is 0.3 μm as shown in FIG. 28A, the wiring region width WD is about 100 μm (≠1.25 μm×64+0.3 μm×63). If the number of bits of gray scale data f or one dot is increased to, for example, 256 gray scales, the wiring region width WD measures about 400 μm.

As described above, the width of wiring region of gray scale voltage signal lines, which extend along the arrangement direction of the data lines, becomes larger as the number of gray scales is increased. In addition, the area of the wiring region of the gray scale voltage signal lines occupies a large fraction of the total area of the data driver. Therefore, the ratio of the area of the wiring region of gray scale voltage signal lines to the total area is getting larger as the number of gray scales is increased, thus causing high manufacturing costs due to the increased layout area.

Furthermore, the voltage difference among gray scale voltages becomes smaller as the number of gray scales is increased as described above, resulting in inevitable demands to fix each gray scale voltage highly accurately.

### SUMMARY

According to a first aspect of the invention, there is provided an impedance conversion circuit for outputting a voltage corresponding to (j+k) (j is a positive integer, k is a positive integer more than 1) bits of gray scale data, the impedance conversion circuit comprising:

an operational amplifier connected as a voltage follower and supplied with, as an input voltage, a voltage selected from 2^{j} levels of voltages based on data of high j bits of the gray scale data; and

an output voltage setting circuit for precharging or discharging an output of the operational amplifier based on data of a most significant bit of low k bits of the gray scale data,

wherein the operational amplifier outputs, as an output voltage, a voltage having a difference from the input voltage by a dead zone width after the output voltage setting circuit precharges or discharges the output of the operational amplifier; and

wherein the dead zone width is determined by an operating current of the operational amplifier, the operating current being varied based on data of the low k bits of the gray scale data.

According to a second aspect of the invention, there is provided a drive circuit for driving an electro-optical device having a plurality of scan lines, a plurality of data lines, and a plurality of pixel electrodes specified by the scan lines and the data lines, the drive circuit comprising:

a voltage selection circuit for outputting, as an input voltage, a voltage selected from 2^{j} levels of voltages based on data of high j bits of gray scale data; and

the above-described impedance conversion circuit,

wherein the output voltage is supplied to any of the data lines.

According to a third aspect of the invention, there is provided a drive circuit for driving an electro-optical device having a plurality of scan lines, a plurality of data lines, and a plurality of pixel electrodes specified by the scan lines and the data lines, the drive circuit comprising:

a voltage selection circuit for outputting, as an input voltage, a voltage selected from 2^{j} levels of voltages based on data of high j bits of gray scale data;

the above-described impedance conversion circuit; and

a current source control voltage generating circuit for generating a voltage that varies based on data of low k bits of the gray scale data,
wherein the current source control voltage generating circuit supplies a gate voltage of at least one of the first and second current source transistors.

According to fourth aspect of the invention, there is provided a method for controlling an impedance conversion circuit for outputting a voltage corresponding to (j+k) (j is a positive integer, k is a positive integer more than 1) bits of gray scale data, the method comprising:

precharging or discharging an output of an operational amplifier connected as a voltage follower based on data of a most significant bit of low k bits of the gray scale data, an input of the operational amplifier being supplied with, as an input voltage, a voltage selected from 2^{j} levels of voltages based on data of high j bits of the gray scale data; and then

outputting, from the operational amplifier, a voltage having a difference from the input voltage by a dead zone width as an output voltage,

wherein the dead zone width is determined by an operating current of the operational amplifier, the operating current being varied based on data of the low k bits of the gray scale data.

### BRIEF DESCRIPTION OF THE SEVERAL VIEWS OF THE DRAWING

FIG. 1 is a block diagram of a liquid crystal device to which an impedance conversion circuit according to an embodiment of the invention is applied.

FIG. 2 is a block diagram of a configuration example of a data driver of FIG. 1.

FIG. 3 is a block diagram of a configuration example of a scan driver of FIG. 1.

FIG. 4 is a diagram showing a configuration example of essential part of the data driver according to the embodiment.

FIG. 5 is an explanatory diagram of an example of the configuration of gray scale data for each one dot.

FIG. 6 is a diagram showing an example of the operation of the impedance conversion circuit according to the embodiment.

FIG. 7 is a diagram showing another example of the operation of the impedance conversion circuit according to the embodiment.

FIG. 8 is a diagram showing an example of a gray scale characteristic of the data driver according to the embodiment.

FIG. 9 is a block diagram showing the schematic configuration of an impedance conversion circuit of a first configuration example of the embodiment.

FIG. 10 is an explanatory diagram for specifically illustrating gray scale data for each one dot.

FIG. 11 is a timing chart of an operation example of the impedance conversion circuit of FIG. 9.

FIG. 12 is a circuit diagram of a configuration example of an operational amplifier of the first configuration example of the embodiment.

FIG. 13 is a diagram for showing an example of a truth table for illustrating the operation of a current control decoder of FIG. 9.

FIG. 14 is a diagram for illustrating the relationship between values represented by data of low (k−1) bits of gray scale data and dead zone width.

FIGS. 15A, 15B and 15C are explanatory diagrams relating to the number of first and second current adjustment transistors.

FIG. 16 is a block diagram showing the schematic configuration of the impedance conversion circuit of the first configuration example in the case in which j is 4 and k is 2.

FIG. 17 is a circuit diagram of a configuration example of an operational amplifier of FIG. 16.

FIG. 18 is a schematic diagram of the configurations of the operational amplifier and an output voltage setting circuit of FIG. 17 when an output is discharged.

FIG. 19 is a diagram showing an example of an operational waveform of an output voltage of the operational amplifier of FIG. 18.

FIG. 20 is a schematic diagram of the configurations of the operational amplifier and the output voltage setting circuit of FIG. 17 when an output is precharged.

FIG. 21 is a diagram showing an example of an operational waveform of an output voltage of the operational amplifier of FIG. 20.

FIG. 22 is a diagram for illustrating an example of a truth table relating to the current control decoder for implementing another control of current values of first and second current sources.

FIG. 23 is a block diagram showing the schematic configuration of an impedance conversion circuit of a second configuration example of the embodiment.

FIG. 24 is a circuit diagram of a configuration example of an operational amplifier of the second configuration example.

FIG. 25 is a diagram for showing an example of a truth table for illustrating the operation of a current control decoder of FIG. 23.

FIG. 26 is a block diagram of the schematic configuration of the impedance conversion circuit of the second configuration example in the case in which k is 2.

FIG. 27 is a diagram showing an example of a truth table for illustrating the operation of the current control decoder in the case in which k is 2.

FIG. 28 is an explanatory diagram for explaining the relationship between the disposal direction of impedance conversion circuits and the arrangement direction of data lines.

FIGS. 28A and 29B are explanatory diagrams of a wiring region for a group of gray scale voltage signal lines.

### DETAILED DESCRIPTION OF THE EMBODIMENTS

An advantage of the invention is to provide an impedance conversion circuit, a drive circuit, and a method of controlling an impedance conversion circuit each capable of reducing the number of gray scale voltage signal lines while maintaining the number of gray scales, and each capable of outputting gray scale voltages highly accurately.

According to one embodiment of the invention, there is provided an impedance conversion circuit for outputting a voltage corresponding to (j+k) (j is a positive integer, k is a positive integer more than 1) bits of gray scale data. The impedance conversion circuit includes: an operational amplifier connected as a voltage follower and supplied with, as an input voltage, a voltage selected from 2^{j} levels of voltages based on data of high j bits of the gray scale data; and an output voltage setting circuit for precharging or discharging an output of the operational amplifier based on data of a most significant bit of low k bits of the gray scale data. The operational amplifier outputs, as an output voltage, a voltage having a difference from the input voltage by a dead zone width after the output voltage setting circuit precharges or discharges the output of the operational amplifier. The dead zone width is determined by an operating current of the operational amplifier. The operating current is varied based on data of the low k bits of the gray scale data.

In this embodiment, any one of 2^{j} levels of voltages corresponding to the high j bits data of (j+k) bits gray scale data is received as the input voltage, and the impedance conversion circuit outputs the voltage corresponding to low k bits of the gray scale data from the 2^{k} levels of voltages based on the input voltage. Therefore, it is enough to select the input voltage from the 2^{j} levels of gray scale voltages. Thus, since the number of gray scale voltage signal lines can be reduced while maintaining the number of gray scales, the number of gray scale voltages to be generated can be reduced. Accordingly, the number of gray scale voltage signal lines supplied with the generated gray scale voltages can be reduced, thus reducing the width of the wiring region. As a result, the ratio of area of the wiring region of the gray scale voltage signal lines to the whole area can be suppressed. Thus, even if the number of gray scales increases, the chip area of the data driver to which the impedance conversion circuit is applied can be reduced to achieve cost reduction.

Furthermore, in this embodiment, the dead zone width is varied by changing the operating current of the operational amplifier to generate each gray scale voltage. Thus, even if voltage differences among gray scale voltages further decrease as the number of gray scales increases, each gray scale voltage can be defined highly precisely.

In this impedance conversion circuit, the operational amplifier may include:

a first-conductivity-type differential amplification circuit having a first differential transistor pair of a first conductivity type and a first current mirror circuit, the first differential transistor pair having a first input-side transistor and a first output-side transistor, a source of each of the first input-side and first output-side transistors being supplied with a current from a first current source, a gate of the first input-side transistor being supplied with the input voltage, a gate of the first output-side transistor being supplied with the output voltage, and the first current mirror circuit generating a drain current of each of the first input-side and first output-side transistors; a second-conductivity-type differential amplification circuit having a second differential transistor pair of a second conductivity type and a second current mirror circuit, the second differential transistor pair having a second input-side transistor and a second output-side transistor, a source of each of the second input-side and second output-side transistors being supplied with a current from a second current source, a gate of the second input-side transistor being supplied with the input voltage, a gate of the second output-side transistor being supplied with the output voltage, and the second current mirror circuit generating a drain current of each of the second input-side and second output-side transistors; and an output circuit having a first drive transistor of the second conductivity type and a second drive transistor of the first conductivity type, a gate voltage of the first drive transistor being controlled based on a drain voltage of the first input-side transistor of the first differential transistor pair, a gate voltage of the second drive transistor being controlled based on a drain voltage of the second input-side transistor of the second differential transistor pair, drains of the first and second drive transistors being coupled to each other, and the output circuit outputting, as the output voltage, a voltage at a coupling node of the drains. A first input-side current driving capability of the first input-side transistor may be lower than a first output-side current driving capability of the first output-side transistor. A second input-side current driving capability of the second input-side transistor may be lower than a second output-side current driving capability of the second output-side transistor. A current of at least one of the first and second current sources may be controlled based on the data of the low k bits of the gray scale data to vary the dead zone width.

Typical operational amplifiers are designed to have no dead zone of the output. However, in this embodiment, the operational amplifier involving the dead zone is used by design and the dead zone is positively utilized. Thus, 2^{k} levels of output voltages can be output for one input voltage with a simple configuration. Therefore, using the impedance conversion circuit as an impedance converter of a data driver can reduce the number of gray scale voltages to be generated to one 2^{k}-th.

The impedance conversion circuit may further include the first current source. The first current source may include: a first current source transistor coupled to the source of each of the first input-side and first output-side transistors of the first differential transistor pair of the first conductivity type, a gate of the first current source transistor being supplied with a first constant voltage; and at least one first current adjustment transistor whose gate is supplied with the first constant voltage. At least one source or at least one drain of the first current adjustment transistor may be electrically coupled to or electrically isolated from a source or a drain of the first current source transistor based on the data of the low k bits of the gray scale data to vary a current of the first current source.

The impedance conversion circuit may further include the second current source. The second current source may include: a second current source transistor coupled to the source of each of the second input-side and second output-side transistors of the second differential transistor pair of the second conductivity type, a gate of the second current source transistor being supplied with a second constant voltage; and at least one second current adjustment transistor whose gate is supplied with the second constant voltage. At least one source or at least one drain of the second current adjustment transistor may be electrically coupled to or electrically isolated from a source or a drain of the second current source transistor based on the data of the low k bits of the gray scale data to vary a current of the second current source.

In this embodiment, the dead zone width can be changed by varying currents supplied to the transistors of the differential transistor pairs based on gray scale data. Therefore, the impedance conversion circuit that can output 4 (=2²) levels or more of voltages for one input voltage with a simple configuration can be provided. Thus, the chip area of a data driver to which the impedance conversion circuit is applied can further be reduced, allowing further cost lowering.

In this impedance conversion circuit, when a current of the first and second current sources is varied based on the data of the low k bits of the gray scale data, a current of the second current source may be decreased when a current of the first current source is increased, while a current of the first current source may be decreased when a current of the second current source is increased.

This embodiment of the invention is based on the fact that the operation of the first differential amplification circuit has no effect on the output circuit when the output is discharged while the operation of the second differential amplification circuit has no effect on the output circuit when the output is precharged. Based on this fact, when either one of the first and second current sources is increased, the current of the other current source is decreased. This current control stops or limits the operation of the differential amplification circuit supplied with the current from the other current source having no effect on the output circuit. Thus, besides the above-described advantages, advantages of decreasing power consumption of the impedance conversion circuit can be obtained.

The impedance conversion circuit may further include the first current source that has a first current source transistor coupled to the source of each of the first input-side and first output-side transistors of the first differential transistor pair of the first conductivity type. A gate of the first current source transistor may be supplied with a voltage that varies based on the data of the low k bits of the gray scale data to vary a current of the first current source.

The impedance conversion circuit may further include the second current source that has a second current source transistor coupled to the source of each of the second input-side and second output-side transistors of the second differential transistor pair of the second conductivity type. A gate of the second current source transistor may be supplied with a voltage that varies based on the data of the low k bits of the gray scale data to vary a current of the second current source.

In this embodiment, the gata voltage of the first or second current source is controlled. Therefore, even if variation of elements such as transistors exist, the current of the first or second current source can be controlled. Thus, the impedance conversion circuit that generates each gray scale voltage more highly accurately can be provided.

In this impedance conversion circuit, the dead zone width may be increased by increasing a current of at least one of the first and second current sources. The dead zone width. may be decreased by decreasing a current of at least one of the first and second current sources.

In this impedance conversion circuit, the output voltage setting circuit may set the output of the operational amplifier to a precharge voltage higher than the input voltage when the output is precharged. The output voltage setting circuit may set the output of the operational amplifier to a discharge voltage lower than the input voltage when the output is discharged.

According to one embodiment of the invention, there is provided a drive circuit for driving an electro-optical device having a plurality of scan lines, a plurality of data lines, and a plurality of pixel electrodes specified by the scan lines and the data lines. The drive circuit includes: a voltage selection circuit for outputting, as an input voltage, a voltage selected from 2^{j} levels of voltages based on data of high j bits of gray scale data; and the above-described impedance conversion circuit. The output voltage is supplied to any of the data lines.

According to one embodiment of the invention, there is provided a drive circuit for driving an electro-optical device having a plurality of scan lines, a plurality of data lines, and a plurality of pixel electrodes specified by the scan lines and the data lines. The drive circuit includes: a voltage selection circuit for outputting, as an input voltage, a voltage selected from 2^{j} levels of voltages based on data of high j bits of gray scale data; the above-described impedance conversion circuit; and a current source control voltage generating circuit for generating a voltage that varies based on data of low k bits of the gray scale data. The current source control voltage generating circuit supplies a gate voltage of at least one of the first and second current source transistors.

Any one of the above drive circuits may further include a reference voltage generating circuit for generating 2^{j} levels of voltages obtained by dividing a voltage between a first supply voltage and a second supply voltage.

In the above embodiments, the drive circuit including the impedance conversion circuit in which the number of gray scale voltage signal lines is reduced while maintaining the number of gray scales, capable of outputting gray scale voltages highly accurately can be provided. Thus, the chip area of the drive circuit can be reduced, allowing cost lowering and increase in gray scales of the drive circuit.

According to one embodiment of the invention, there is provided a method for controlling an impedance conversion circuit for outputting a voltage corresponding to (j+k) (j is a positive integer, k is a positive integer more than 1) bits of gray scale data. The method includes: precharging or discharging an output of an operational amplifier connected as a voltage follower based on data of a most significant bit of low k bits of the gray scale data, an input of the operational amplifier being supplied with, as an input voltage, a voltage selected from 2^{j} levels of voltages based on data of high j bits of the gray scale data; and outputting, from the operational amplifier, a voltage having a difference from the input voltage by a dead zone width as an output voltage. The dead zone width is determined by an operating current of the operational amplifier. The operating current is varied based on data of the low k bits of the gray scale data.

These embodiments will be described below in detail with reference to the drawings. Note that the embodiments described below do not unreasonably limit the invention set forth in claims. Furthermore, all components described below are not necessarily essential elements of the invention.

1. Liquid Crystal Device

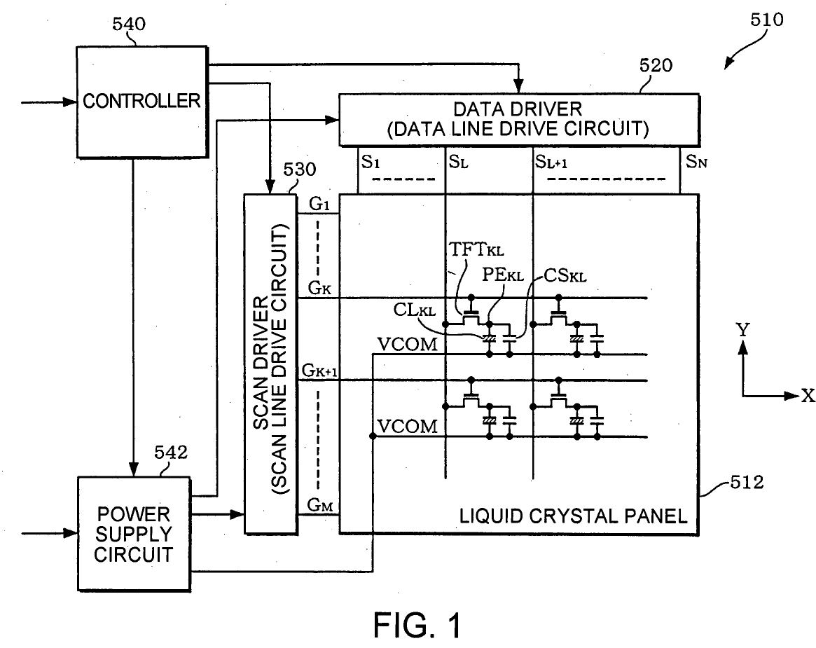

FIG. 1 shows an example of a block diagram of a liquid crystal device including an impedance conversion circuit according to an embodiment of the invention.

The liquid crystal device (a display device, in a broad sense) 510 includes a liquid crystal panel (a display panel, in a broad sense) 512, a data driver (a data line drive circuit) 520, a scan driver (a scan line drive circuit) 530, a controller 540, and a power supply circuit 542. The liquid crystal device 510 does not necessarily need to include all of these circuit blocks. Part of these circuit blocks may be omitted.

The liquid crystal panel (in a broad sense, a display panel or an electro-optical device) 512 includes a plurality of scan lines (in a narrow sense, gate lines), a plurality of data lines (in a narrow sense, source lines), and a plurality of pixel electrodes specified by the plurality of scan lines and the plurality of data lines. In this case, an active matrix liquid crystal display device can be fabricated by coupling thin film transistors (TFT, in a broad sense, a switching element) to the data lines and coupling the pixel electrodes to the TFTs.

More specifically, the liquid crystal panel 512 is formed on an active matrix substrate (e.g., a glass substrate). On the active matrix substrate, there are disposed scan lines G₁ to G_{M} (M denotes a natural number equal to or greater than two.) arranged across the Y direction in FIG. 1 and each extending along the X direction, and data lines S₁ to S_{N} (N denotes a natural number equal to or greater than two.) arranged across the X direction and each extending along the Y direction. Furthermore, a thin film transistor TFT_{KL} (in a broad sense, a switching element) is provided at a position corresponding to the intersection of the scan line G_{K} (1≦K≦M, K denotes a natural number.) and the data line S_{L} (1≦L≦N, L denotes a natural number.).

The gate electrode of the TFT_{KL} is coupled to the scan line G_{K}, the source electrode of the TFT_{KL} is coupled to the data line S_{L}, and the drain electrode of the TFT_{KL} is coupled to a pixel electrode PE_{KL}. A liquid crystal capacitance CL_{KL} (a liquid crystal element) and an auxiliary capacitance CS_{KL} are formed between the pixel electrode PE_{KL} and an opposing electrode (a common electrode) VCOM facing the pixel electrode PE_{KL} with the intermediary of a liquid crystal element (in a broad sense, an electro-optical material). A liquid crystal is enclosed between the active matrix substrate, on which the TFT_{KL}, the pixel electrode PE_{KL}, and so on are formed, and the opposing substrate with the opposing electrode VCOM formed thereon so that the transmittance of the pixels changes in accordance with the voltage applied between the pixel electrode PE_{KL} and the opposing electrode VCOM.

A common voltage applied to the opposing electrode VCOM is generated by the power supply circuit 542. The opposing electrode VCOM may be formed in strips corresponding to the respective scan lines instead of being formed over the entire opposing substrate.

The data driver 520 drives the data lines S₁ to S_{N} of the liquid crystal panel 512 based on the gray scale data. The scan driver 530 sequentially scans the scan lines G₁ to G_{M} of the liquid crystal panel 512.

The controller 540 controls the data driver 520, the scan driver 530, and the power supply circuit 542 based on the contents set by a host such as a central processing unit (CPU) not shown in the drawing.

More specifically, the controller 540 executes for the data driver 520 and the scan driver 530, for example, setting of the operation mode and supplying of a vertical sync signal and a horizontal sync signal generated inside thereof, and executes for the power supply circuit 542 controlling of the polarity inversion timing of the common voltage of the opposing electrode VCOM.

The power supply circuit 542 generates various voltages necessary for driving the liquid crystal panel 512 and the common voltage of the opposing electrode VCOM based on a reference voltage supplied externally.

Although the liquid crystal device 510 includes the controller 540 in FIG. 1, the controller 540 may be provided outside the liquid crystal device 510. Alternatively, the liquid crystal device 510 may include a host in combination with the controller 540. Furthermore, part or all of the data driver 520, the scan driver 530, the controller 540, and the power supply circuit 542 may be formed on the liquid crystal panel 512.

1.1 Data Line Drive Circuit

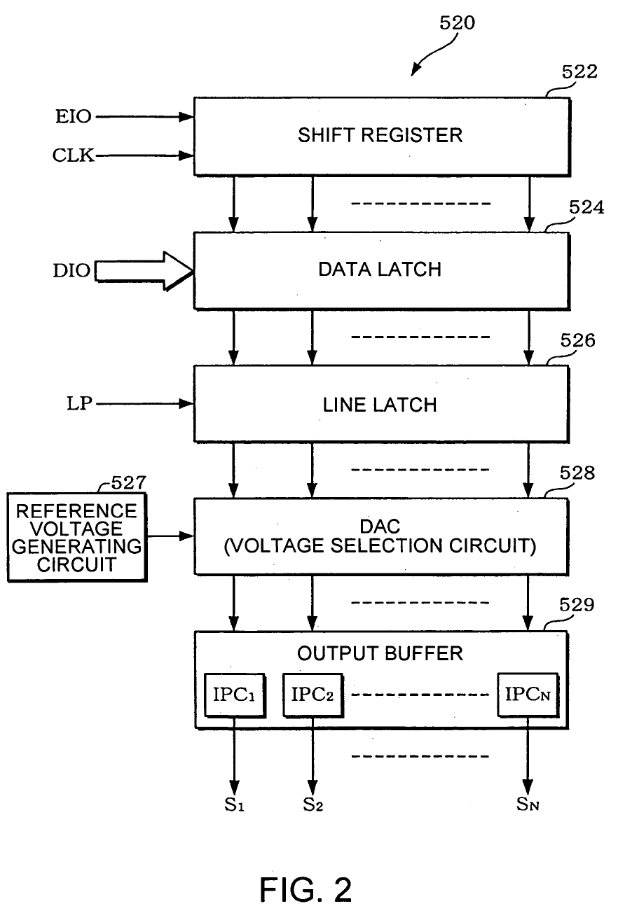

FIG. 2 shows a configuration example of the data driver 520 shown in FIG. 1.

The data driver 520 includes a shift register 522, a data latch 524, a line latch 526, a reference voltage generating circuit 527, a digital to analog conversion circuit (DAC) 528 (a voltage selection circuit, in a broad sense), and an output buffer 529.

The shift register 522 is provided corresponding to each of the data lines and includes a plurality of cascaded flip-flops. The shift register 522 holds an enable input/output signal EIO in sync with a clock signal CLK, and then sequentially shifts the enable input/output signal EIO to the adjacent flip-flop in sync with the clock signal CLK.

The gray scale data (DIO) (digital data, in a broad sense) is input to the data latch 524 by the unit of, for example, 18 bits (6 bits (gray scale data) multiplied by 3 (RGB colors)) from the controller 540. The data latch 524 latches the gray scale data (DIO) in sync with the enable input/output signal EIO sequentially shifted by the flip-flops of the shift register 522.

The line latch 526 latches, in sync with the horizontal sync signal LP supplied from the controller 540, one horizontal scan unit of the gray scale data latched by the data latch 524.

The reference voltage generating circuit 527 generates plural reference voltages (gray scale voltages) corresponding to the respective gray scale data. The reference voltage generating circuit 527 includes a gamma correction resistor, and outputs, as the gray scale voltages, voltages obtained by dividing the voltage across the gamma correction resistor with resistor elements. Therefore, the gray scale voltages corresponding to the gray scale data can be adjusted by tuning the resistance ratio of the resistor elements, thus allowing so-called gamma correction.

The DAC 528 generates analog gray scale voltages to be supplied to the data lines. Specifically, the DAC 528 selects any one gray scale voltage from the plural gray scale voltages generated by the reference voltage generating circuit 527 in accordance with the digital gray scale data (digital data) from the line latch 526, and outputs the voltage as an analog gray scale voltage corresponding to the digital gray scale data (digital data).

The output buffer 529 buffers the gray scale voltages from the DAC 528 to output the voltages to the data lines, so as to drive the data lines. Specifically, the output buffer 529 includes impedance conversion circuits IPC₁ to IPC_{N} provided for the respective data lines. The impedance conversion circuit implements impedance conversion of the gray scale voltage from the DAC 528, and outputs a resultant voltage to the corresponding data line. Each of the impedance conversion circuits includes an operational amplifier (Op-Amp) connected as a voltage follower.

1.2 Scan Driver

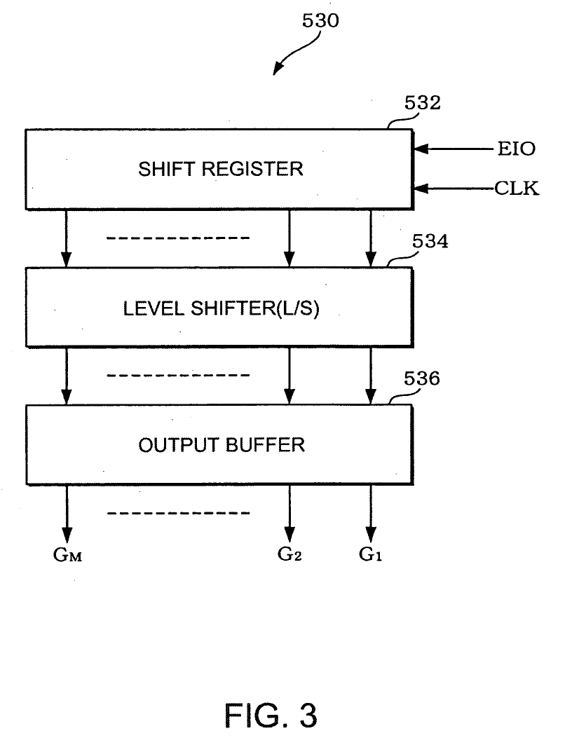

FIG. 3 shows a configuration example of the scan driver 530 shown in FIG. 1.

The scan driver 530 includes a shift register 532, a level shifter 534, and an output buffer 536.

The shift register 532 is provided corresponding to each of the scan lines and includes a plurality of cascaded flip-flops. The shift register 532 holds the enable input/output signal EIO in sync with the clock signal CLK, and then sequentially shifts the enable input/output signal EIO to the adjacent flip-flop in sync with the clock signal CLK. The input enable input/output signal EIO is a vertical sync signal supplied from the controller 540.

The level shifter 534 shifts the voltage level from the shift register 532 to a voltage level suitable for the liquid crystal element of the liquid crystal panel 512 and the capacity of the TFT as a transistor. As the voltage level, for example, a high voltage level in the range of 20-50 V is required.

The output buffer 536 buffers the scan voltages shifted by the level shifter 534 and outputs the voltages to the scan lines, so as to drive the scan lines.

2. Impedance Conversion Circuit

Using the impedance conversion circuit of the present embodiment can reduce the number of gray scale voltage signal lines while maintaining the number of gray scales.

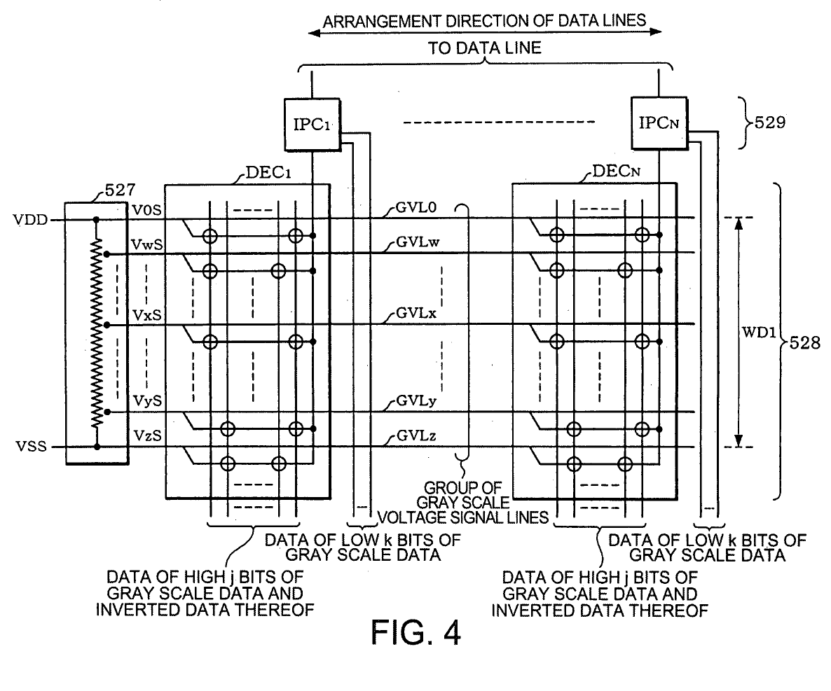

FIG. 4 shows a configuration example of essential part of the data driver according to the present embodiment. The same parts as those of the data driver 520 shown in FIG. 2 are given the same reference numerals and explanations thereof will be omitted appropriately.

The reference voltage generating circuit 527 includes a gamma correction resistor. The gamma correction resistor outputs voltages obtained by resistively dividing the voltage between the system supply voltage VDD (a first supply voltage) and the system ground supply voltage VSS (a second supply voltage) as gray scale voltages V0S, VwS, . . . , VxS, . . . , VyS, and VzS.

The gray scale voltage signal lines GVL0, GVLw, . . . , GVLx, . . . , GVLy, and GVLz are supplied with the gray scale voltages V0S, VwS, . . . , VxS, . . . , VyS, and VzS, respectively.

The DAC 528 includes the first to N^{th} decoders DEC₁ to DEC_{N} provided for the respective data lines. Each of the decoders selects from the gray scale voltages V0S, VwS, . . . , VxS, . . . , VyS, and VzS the gray scale voltage corresponding to the data of high j bits of (j+k) (j is a positive integer, and k is an integer equal to or greater then one.) bits of gray scale data corresponding to the data lines. For example, each of the decoders is composed of a so-called ROM, and selects any one of the gray scale voltages V0S, VwS, . . . , VxS, . . . , VyS, and VzS from the reference voltage generating circuit 527 in accordance with the data of high j bits of the gray scale data or the inverted data thereof.

The output buffer 529 includes the impedance conversion circuits IPC₁ to IPC_{N} provided for the respective data lines. The impedance conversion circuit IPCₕ (1≦h≦N, h denotes an integer) is supplied with the gray scale voltage selected by the h^{th} decoder DECₕ as an input voltage. Specifically, the impedance conversion circuit IPCₕ is supplied with the voltage, as its input voltage, selected from 2^{j} levels of voltages in accordance with the data of high j bits of the gray scale data. Subsequently, the impedance conversion circuit IPCₕ outputs to the data line Sₕ a voltage corresponding to the data of low k bits of the gray scale data, selected from 2^{k} levels of voltages obtained by shifting the potential of the input voltage.

Thus, the number of gray scale voltage signal lines coupled to the decoders of the DAC 528 can be reduced to 2^{j} in the present embodiment, in contrast to the configuration of FIG. 28, including 2^{(j+k)} lines, for example.

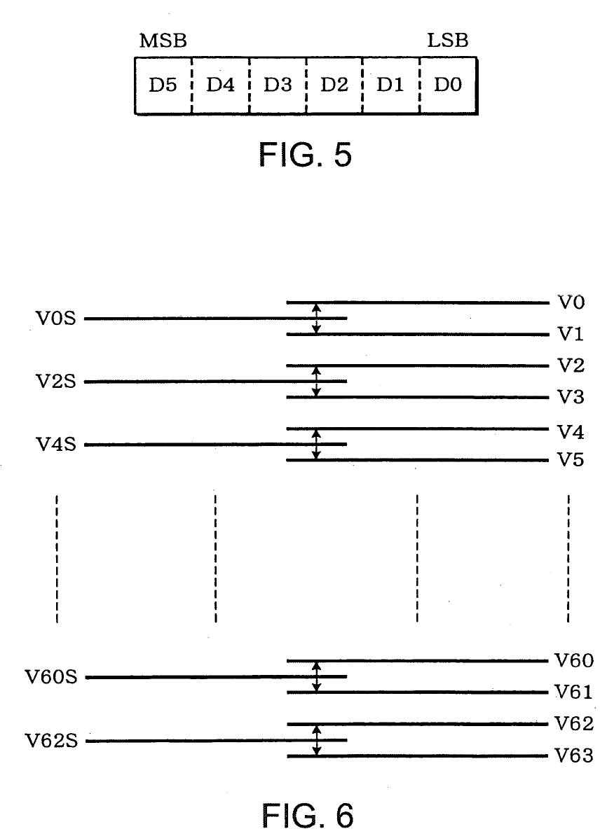

FIG. 5 shows a configuration example of gray scale data for one dot.

The gray scale data shown in FIG. 5 is generated for each of the data lines. The gray scale data is composed of 6 bits in which the most significant bit is denoted with D5 while the least significant bit is denoted with D0. Using gray scale data of such a composition allows the expression of 64 gray scales for one dot.

FIG. 6 shows an example of operation of the impedance conversion circuit according to the present embodiment.

FIG. 6 shows the operation example of the case in which the impedance conversion circuit shown in FIG. 4 outputs, as the output voltage, a voltage corresponding to the data of the least significant bit of 6-bit gray scale data, for example. That is, the case in which k is 1 is shown. In this case, the impedance conversion circuit shown in FIG. 4 outputs any one of 2¹ levels of voltages as the output voltage.

In order to express 64 gray scales, the impedance conversion circuit needs to output the gray scale voltages V0 to V63. In this case, an input voltage to the impedance conversion circuit is any one of the gray scale voltages V0S, V2S, V4S, . . . , V60S, and V62S. Therefore, it is sufficient that the decoder for selecting the input voltage to the impedance conversion circuit is coupled to a group of gray scale voltage signal lines supplied with the gray scale voltages V0S to V62S. Specifically, it is sufficient that the number of gray scale voltages generated by the reference voltage generating circuit 527 is 32.

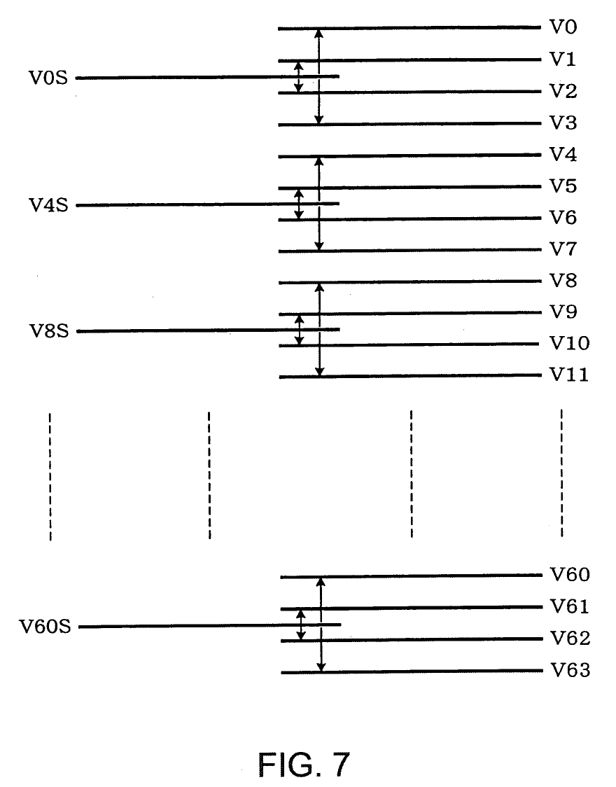

FIG. 7 shows another example of operation of the impedance conversion circuit according to the present embodiment.

FIG. 7 shows an operation example for the case in which the impedance conversion circuit shown in FIG. 4 outputs, as the output voltage, a voltage corresponding to the data of low two bits of 6-bit gray scale data, for example. That is, the case in which k is 2 is shown. In this case, it is enough that the impedance conversion circuit of FIG. 4 outputs any one of 2² levels of voltages as the output voltage.

In the case of expressing 64 gray scales, it is sufficient that the input voltage to the impedance conversion circuit is any one of the gray scale voltages V0S, V4S, V8S, . . . , V56S, and V60S. Therefore, it is sufficient that the decoder for selecting the input voltage to the impedance conversion circuit is coupled to a group of gray scale voltage signal lines supplied with the gray scale voltages V0S to V60S. Specifically, it is sufficient that the number of gray scale voltages generated by the reference voltage generating circuit 527 is 16.

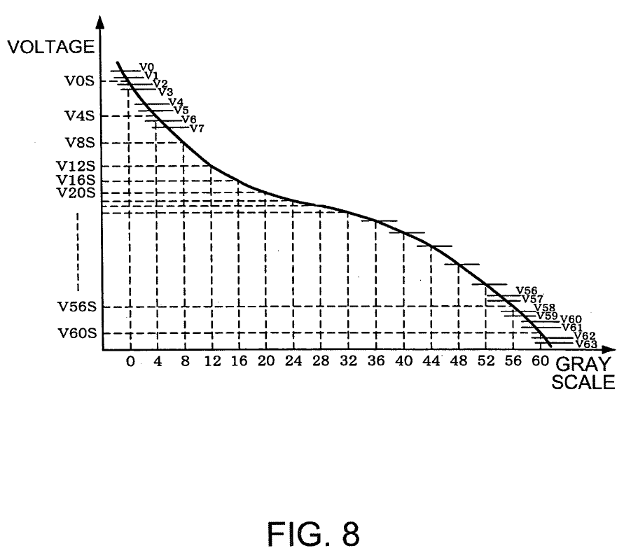

FIG. 8 shows an example of a gray scale characteristic of the data driver according to the present embodiment.

FIG. 8 shows the gray scale characteristic of the data driver 520 according to the present embodiment, including the impedance conversion circuit performing the operation shown in FIG. 7. In this case, the number of gray scale voltages, on the vertical axis, supplied to the gray scale voltage signal lines can be reduced while maintaining the number of gray scales (=64), on the horizontal axis.

As described above, the impedance conversion circuit can supply the data line with any one of 2^{(j+k)} levels of gray scale voltages in accordance with (j+k) bits of gray scale data. In addition, since the impedance conversion circuit is adapted to output the gray scale voltage corresponding to the low k bits of the gray scale data, it is enough for the decoder to select the gray scale voltage from 2^{j} levels of gray scale voltages. Accordingly, the number of gray scale voltages generated by the reference voltage generating circuit 527 can be reduced. Thus, the number of gray scale voltage signal lines can also be reduced, allowing reduction of the wiring region width WD1 shown in FIG. 4. Therefore, since the ratio of area of the wiring region for the gray scale voltage signal lines to the total area can be suppressed, a data driver having a small chip size even with a large number of gray scales can be provided.

2.1 First Configuration Example

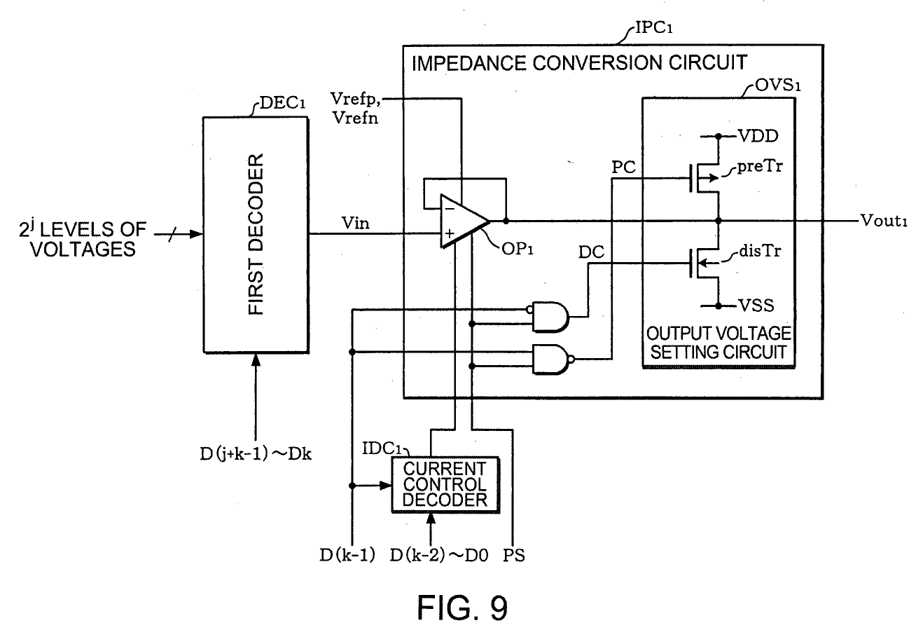

FIG. 9 is a block diagram showing the schematic configuration of an impedance conversion circuit of a first configuration example of the present embodiment. Although FIG. 9 illustrates the configuration example of only the impedance conversion circuit IPC₁, configurations of other impedance conversion circuits IPC₂ to IPC_{N} are the same.

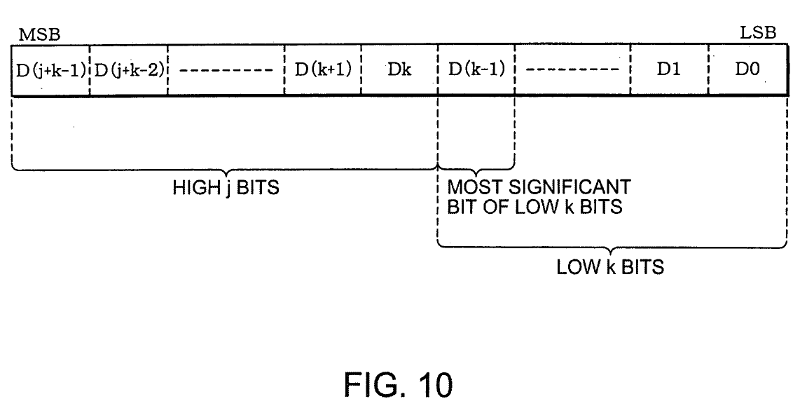

FIG. 10 shows a configuration example of gray scale data for one dot according to the present embodiment.

The impedance conversion circuit IPC₁ outputs an output voltage Vout₁ corresponding to (j+k) bits of gray scale data. In the present embodiment, the (j+k) bits of gray scale data are used for each one dot. If the gray scale data is expressed as D(j+k−1) to D0, the data of high j bits of the gray scale data can be expressed as D(j+k−1) to Dk, while the data of low k bits of the gray scale data can be expressed as D(k−1) to D0. In this case, the data of the most significant bit of low k bits of the gray scale data is expressed as D(k−1).

The impedance conversion circuit IPC₁ outputs a gray scale voltage corresponding to the low k bits of the gray scale data. For this purpose, the impedance conversion circuit IPC₁ includes a current control decoder IDC₁ internally or externally. The current control decoder IDC₁ decodes the data D(k−1) to D0 of low k bits of the gray scale data to output control signals corresponding to the data D(k−1) to D0. The current value of an operating current of the operational amplifier OP₁ is increased or decreased based on the control signals. Such a current control decoder is provided for each impedance conversion circuit.

Referring to FIG. 9, the input voltage to the impedance conversion circuit IPC₁ is selected by the first decoder DEC₁. As described above, the first decoder DEC₁ selects any one of 2^{j} levels of gray scale voltages generated by the reference voltage generating circuit 527 based on the data of high j bits of the gray scale data and the inverted data thereof, so as to output the voltage as the input voltage Vin to the impedance conversion circuit IPC₁.

The impedance conversion circuit IPC₁ includes the operational amplifier OP₁ connected as a voltage follower and an output voltage setting circuit OVS₁. An input of the operational amplifier OP₁ connected as a voltage follower is supplied with the input voltage Vin. The operational amplifier OP₁ drives the data line S₁. The operational amplifier OP₁ connected as a voltage follower outputs a voltage different from the input voltage Vin by a predetermined amount of voltage called a dead zone. The width of the dead zone is defined by an operating current of the operational amplifier OP₁, varied based on the data D(k−1) to D0 of low k bits of the gray scale data. The operational amplifier OP₁ stops or starts driving of the output in accordance with a power save signal PS.

The output voltage setting circuit OVS₁ precharges or discharges the output of the operational amplifier OP₁ in accordance with the data D(k−1) of the data of the most significant bit of low k bits of the gray scale data. In FIG. 9, when the output is precharged, the output of the operational amplifier OP₁ is set to the system supply voltage VDD as a precharge voltage, and when discharged, the output of the operational amplifier OP₁ is set to the system ground supply voltage VSS as a discharge voltage. Any precharge voltage is available as long as it is higher than the input voltage Vin. Any discharge voltage is available as long as it is lower than the input voltage Vin.

The output voltage setting circuit OVS₁ includes a precharge transistor preTr and a discharge transistor disTr. The precharge transistor preTr is composed of a p-type metal oxide semiconductor (MOS) transistor. The discharge transistor disTr is composed of an n-type MOS transistor. The source of the precharge transistor preTr is supplied with the precharge voltage, and the drain thereof is coupled to the output of the operational amplifier OP₁. The source of the discharge transistor disTr is supplied with the discharge voltage, and the drain thereof is coupled to the output of the operational amplifier OP₁.

In FIG. 9, when driving of output of the operational amplifier OP₁ is stopped by the power save signal PS (or an inverted signal XPS), the precharge control signal PC resulting from logical operation between the power save signal PS and the data D(k−1) of the most significant bit of low k bits of the gray scale data, is supplied to the gate of the precharge transistor preTr. Furthermore, the gate of the discharge transistor disTr is supplied with a discharge control signal DC resulting from logical operation between the power save signal PS and the data D(k−1). The precharge and discharge transistors preTr and disTr are controlled so that they are not simultaneously turned on.

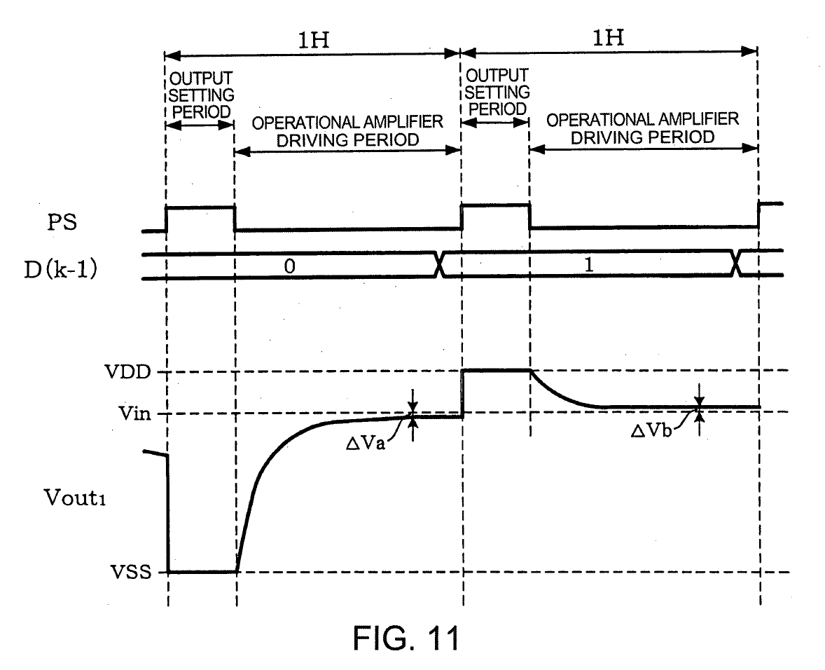

FIG. 11 shows a timing chart of the operation example of the impedance conversion circuit IPC₁ shown in FIG. 9.

In FIG. 11, one horizontal scan period (driving period, in a broad sense) of the liquid crystal panel 512 shown in FIG. 1 is defined as 1H. In an output setting period (a first period), which is the beginning part of the driving period, the operational amplifier OP₁ stops driving the output, and the output voltage setting circuit OVS₁ precharges or discharges the output of the operational amplifier OP₁. More specifically, when the power save signal PS is turned to an H level and the data D(k−1) of the most significant bit of low k bits of the gray scale data is set to “0,” the output voltage setting circuit OVS₁ discharges the output of the operational amplifier OP₁. In contrast, when the power save signal PS is turned to an H level and the data D(k−1) of the most significant bit of low k bits of the gray scale data is set to “1,” the output voltage setting circuit OVS₁ precharges the output of the operational amplifier OP₁.

Subsequently, in a operational amplifier driving period (a second period of the driving period) following the output setting period, the operational amplifier OP₁ starts driving its output to output a voltage different from the input voltage Vin by a dead zone width ΔVa (ΔVb) of the operational amplifier OP₁ as the output voltage. More specifically, when the power save signal PS is turned to an L level, the voltage shifted from the discharge voltage to be lower than the input voltage Vin by the dead zone width ΔVa is output as the output voltage. Alternatively, when the power save signal PS is turned to an L level, the voltage shifted from the precharge voltage to be higher than the input voltage Vin by the dead zone width ΔVb is output as the output voltage.

For example, assuming that input voltage Vin is the gray scale voltage V4S, after the discharge is executed, a voltage lower than the gray scale voltage V4S by the dead zone width ΔVa is output as the gray scale voltage V5. In contrast, after the precharge is executed, a voltage higher than the gray scale voltage V4S by the dead zone width ΔVb is output as the gray scale voltage V4.

In the present embodiment, changes of operating currents of the operational amplifier OP₁ determine the dead zone widths ΔVa and ΔVb. Therefore, the dead zone width can be determined highly accurately even if variation among elements exist, and thus gray scale voltages can be output accurately.

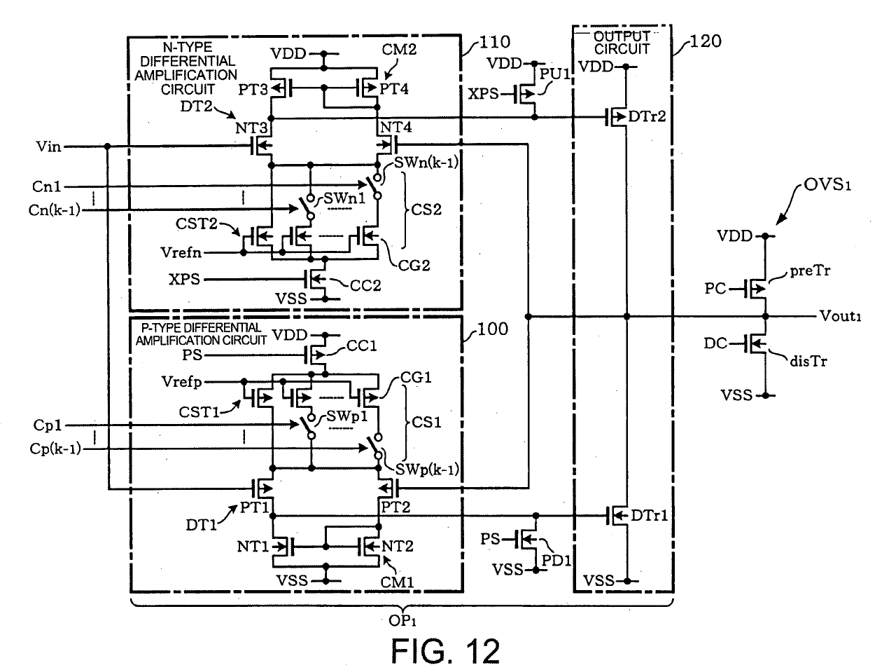

FIG. 12 is a circuit diagram of a configuration example of the operational amplifier OP₁ according to the first configuration example of the present embodiment. FIG. 12 also illustrates the configuration of the output setting circuit OVS₁ in addition to that of the operational amplifier OP₁.

The operational amplifier OP₁ includes a p-type (a first conductivity type, in a broad sense) differential amplification circuit 100, an n-type (a second conduction type, in a broad sense) differential amplification circuit 110, and an output circuit 120.

The p-type differential amplification circuit 100 includes a first differential transistor pair DT1 of the p-type and a first current mirror circuit CM1. The first differential transistor pair DT1 includes p-type MOS transistors (first input-side and first output-side transistors) PT1 and PT2. The source of each of the transistors PT1 and PT2 is supplied with a current from a first current source CS1. The gate of the transistor PT1 is supplied with the input voltage Vin. The gate of the transistor PT2 is supplied with the output voltage Vout₁.

The first current source CS1 includes a first current source transistor CST1 and one or more first current adjustment transistors CG1. The gate of the first current source transistor CST1 and the gate of each of one or more first current adjustment transistors CG1 are supplied with a reference voltage Vrefp (first constant voltage) that is a constant voltage for generating a constant current. The first current source transistor CST1 is a p-type MOS transistor, and the source or drain thereof is coupled to the sources of the transistors PT1 and PT2. The drain or source of the first current source transistor CST1 is coupled to the drain of a p-type MOS transistor CC1 for controlling the first current source. Each of one or more first current adjustment transistors CG1 is a p-type MOS transistor, and the source or drain thereof is coupled via a switch element to the sources of the transistors PT1 and PT2. In FIG. 12, the number of the first current adjustment transistors CG1 is (k−1), and each transistor is coupled via a switch element to the sources of the transistors PT1 and PT2. The switch elements SWp1 to SWp(k−1) are turned on and off based on control signals Cp1 to Cp(k−1). The control signals Cp1 to Cp(k−1) are generated by the current control decoder IDC₁ shown in FIG. 9.

The first current source CS1 of such configuration can control a current (increase or decrease a current) supplied to the transistors PT1 and PT2 of the first differential transistor pair DT1 in accordance with the control signals Cp1 to Cp(k−1).

The source of the transistor CC1 is supplied with the system supply voltage VDD while its gate is supplied with the power save signal PS. Switching on the transistor CC1 allows the generation of a current from the first current source CS1, while switching off the transistor CC1 can stop the generation of a current from the first current source CS1.

The first current mirror circuit CM1 generates the drain current of the transistors PT1 and PT2. More specifically, the first current mirror circuit CM1 includes n-type MOS transistors NT1 and NT2 whose gates are coupled to each other, and the sources of the transistors NT1 and NT2 are supplied with the system ground supply voltage VSS. The drain of the transistor NT1 is coupled to the drain of the transistor PT1. The drain of the transistor NT2 is coupled to the drain of the transistor PT2 and the gate of the transistor NT2.

The n-type differential amplification circuit 110 includes a second differential transistor pair DT2 of the n-type and a second current mirror circuit CM2. The second differential transistor pair DT2 includes n-type MOS transistors (second input-side and second output-side transistors) NT3 and NT4. The source of each of the transistors NT3 and NT4 is supplied with a current from a second current source CS2. The gate of the transistor NT3 is supplied with the input voltage Vin. The gate of the transistor NT4 is supplied with the output voltage Vout₁.

The second current source CS2 includes a second current source transistor CST2 and one or more second current adjustment transistors CG2. The gate of the second current source transistor CST2 and the gate of each of one or more second current adjustment transistors CG2 are supplied with a reference voltage Vrefn (second constant voltage) that is a constant voltage for generating a constant current. The second current source transistor CST2 is an n-type MOS transistor, and the source or drain thereof is coupled to the sources of the transistors NT3 and NT4. The drain or source of the second current source transistor CST2 is coupled to the drain of an n-type MOS transistor CC2 for controlling the second current source. Each of one or more second current adjustment transistors CG2 is an n-type MOS transistor, and the source or drain thereof is coupled via a switch element to the sources of the transistors NT3 and NT4. In FIG. 12, the number of the second current adjustment transistors CG2 is (k−1), and each transistor is coupled via a switch element to the sources of the transistors NT3 and NT4. The switch elements SWn1 to SWn(k−1) are turned on and off based on control signals Cn1 to Cn(k−1). The control signals Cn1 to Cn(k−1) are generated by the current control decoder IDC₁ shown in FIG. 9.

The second current source CS2 of such configuration can control a current (increase or decrease a current) supplied to the transistors NT3 and NT4 of the second differential transistor pair DT2 in accordance with the control signals Cn1 to Cn(k−1).

The source of the transistor CC2 is supplied with the system ground supply voltage VSS while its gate is supplied with the inverted signal XPS of the power save signal PS. Switching on the transistor CC2 allows the generation of a current from the second current source CS2, while switching off the transistor CC2 can stop the generation of a current from the second current source CS2.

The second current mirror circuit CM2 generates the drain current of the transistors NT3 and NT4. More specifically, the second current mirror circuit CM2 includes p-type MOS transistors PT3 and PT4 whose gates are coupled to each other, and the sources of the transistors PT3 and PT4 are supplied with the system supply voltage VDD. The drain of the transistor PT3 is coupled to the drain of the transistor NT3. The drain of the transistor PT4 is coupled to the drain of the transistor NT4 and the gate of the transistor PT4.

The output circuit 120 includes a first drive transistor Dtr1 and a second drive transistor Dtr2. The output circuit 120 outputs, as the output voltage Vout₁, the voltage at a coupling node of the drains of the first and second drive transistors Dtr1 and Dtr2.

The first drive transistor Dtr1 is an n-type MOS transistor. The source of the n-type MOS transistor is supplied with the system ground supply voltage VSS. Furthermore, the gate voltage of the n-type MOS transistor is controlled based on the drain voltage of the transistor PT1 of the first differential transistor pair DT1 (the input-side transistor, of the transistors of the first differential transistor pair, whose gate is supplied with the input voltage Vin). The gate of the first drive transistor Dtr1 is coupled to the drain of an n-type MOS transistor PD1 for pull down. The source of the transistor PD1 is supplied with the system ground supply voltage VSS while its gate is supplied with the power save signal PS. Accordingly, when the power save signal PS is turned to an H level, the gate voltage of the first drive transistor Dtr1 is fixed, and thereby the operation of the first drive transistor Dtr1 can be stabilized.

The second drive transistor Dtr2 is a p-type MOS transistor. The source of the p-type MOS transistor is supplied with the system supply voltage VDD. Furthermore, the gate voltage of the p-type MOS transistor is controlled based on the drain voltage of the transistor NT3 of the second differential transistor pair DT2 (the input-side transistor, of the transistors of the second differential transistor pair, whose gate is supplied with the input voltage Vin). The gate of the second drive transistor Dtr2 is coupled to the drain of a p-type MOS transistor PU1 for pull up. The source of the transistor PU1 is supplied with the system supply voltage VDD while its gate is supplied with the inverted signal XPS of the power save signal PS. Accordingly, when the inverted signal XPS of the power save signal PS is turned to an L level, the gate voltage of the second drive transistor Dtr2 is fixed, and thereby the operation of the second drive transistor Dtr2 can be stabilized.

The first differential transistor pair DT1 is arranged so that the current driving capability of the transistor PT1, which is the input-side transistor, is lower than the current driving capability of the transistor PT2 (the output-side transistor, that is, the other transistor of the transistors of the first differential transistor pair DT1). Therefore, if the gate voltages of the transistors PT1 and PT2 are the same, the driving capability of the transistor PT2 is higher than that of the transistor PT1. Such a first differential transistor pair DT1 can be achieved by, for example, setting W/L of the transistor PT1 to be smaller than W/L of the transistor PT2, in which W denotes the channel width of each transistor and L denotes the channel length of each transistor.

Similarly, the second differential transistor pair DT2 is arranged so that the current driving capability of the transistor NT3, which is the input-side transistor, is lower than the current driving capability of the transistor NT4 (the output-side transistor, that is, the other transistor of the transistors of the second differential transistor pair DT2). Therefore, if the gate voltages of the transistors NT3 and NT4 are the same, the driving capability of the transistor NT4 is higher than that of the transistor NT3. Such a second differential transistor pair DT2 can be achieved by, for example, setting W/L of the transistor NT3 to be smaller than W/L of the transistor NT4.

Thus, the output voltage Vout₁ of the operational amplifier OP₁ can be a voltage different from the input voltage Vin by a dead zone width. The dead zone width corresponds to the difference of the current driving capability between the transistors of each differential transistor pair. In addition, the dead zone width can be varied by changing the current value of at least one of the first and second current sources. The current value is controlled by the control signals Cp1 to Cp(k−1) and Cn1 to Cn(k−1).

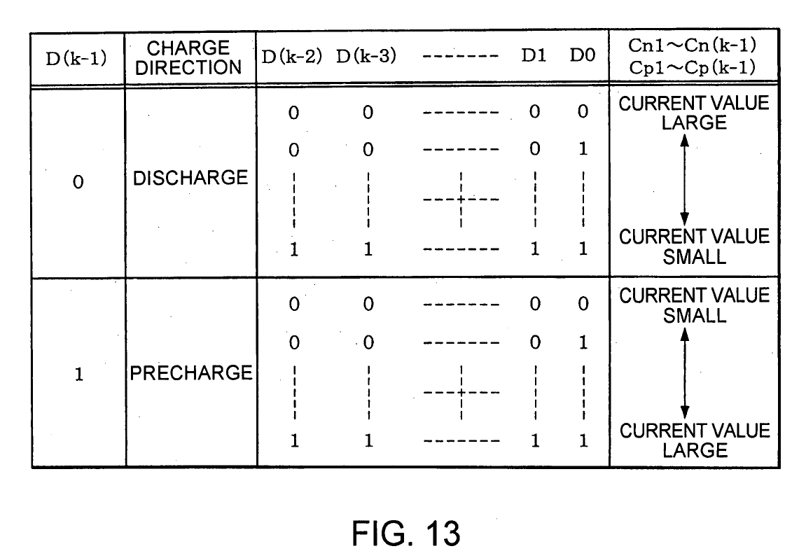

FIG. 13 shows an example of a truth table for illustrating the operation of the current control decoder IDC₁ of FIG. 9.

The data D(k−1) to D0 of low k bits of the gray scale data is input to the current control decoder IDC₁. If the data D(k−1) is “0”, the output voltage setting circuit OVS₁ discharges the output of the operational amplifier OP₁. The voltage control decoder IDC1 generates such control signals Cp1 to Cp(k−1) and Cn1 to Cn(k−1) that the current values of the first and second current sources CS1 and CS2 become smaller as values represented by the data D(k−2) to D0 become larger from “00 . . . 00” to “11 . . . 11”.

If the data D(k−1) is “1”, the output voltage setting circuit OVS₁ precharges the output of the operational amplifier OP₁. The voltage control decoder IDC₁ generates such control signals Cp1 to Cp(k−1) and Cn1 to Cn(k−1) that the current values of the first and second current sources CS1 and CS2 become larger as values represented by the data D(k−2) to D0 become larger from “00 . . . 00” to “11 . . . 11”.

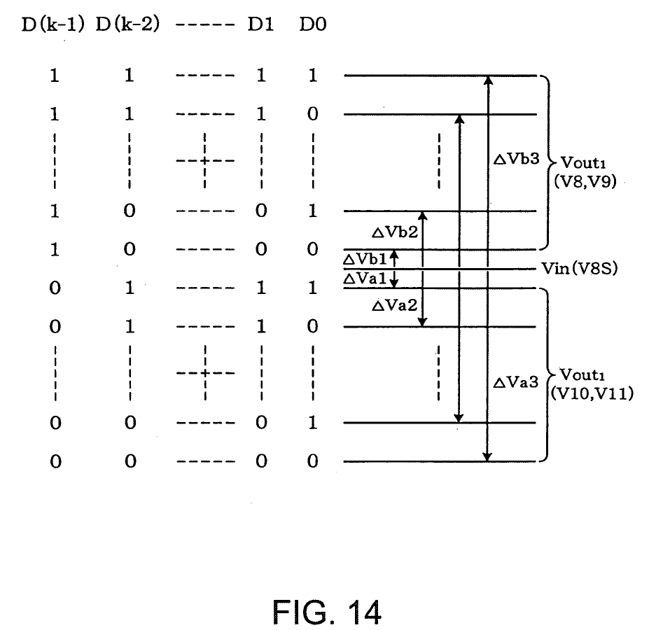

FIG. 14 illustrates the relationship between the values represented by data D(k−2) to D0 and the dead zone width.

As described for FIG. 11, when the output is precharged, the output voltage Vout₁ is a voltage higher than the input voltage Vin by the dead zone width. When the output is discharged, the output voltage Vout₁ is a voltage lower than the input voltage Vin by the dead zone width. The dead zone width is associated with the values represented by the data D(k−2) to D0.

For example, when the data D(k−1) is “1” and the data D(k−2) to D0 is “00 . . . 00”, the output is precharged and thereafter a voltage higher than the input voltage Vin by the dead zone width ΔVb1 is output as the output voltage Vout₁. When the data D(k−1) is “1” and the data D(k−2) to D0 is “00 . . . 01”, a voltage higher than the input voltage Vin by the dead zone width ΔVb2 is output as the output voltage Vout₁ after precharge. Furthermore, when the data D(k−1) is “1” and the data D(k−2) to D0 is “1 . . . 1”, a voltage higher than the input voltage Vin by the dead zone width ΔVb3 is output as the output voltage Vout₁ after precharge.

In contrast, for example, when the data D(k−1) is “0” and the data D(k−2) to D0 is “1 . . . 1”, the output is discharged and thereafter a voltage lower than the input voltage Vin by the dead zone width ΔVa1 is output as the output voltage Vout₁. When the data D(k−1) is “0” and the data D(k−2) to D0 is “1 . . . 10”, a voltage lower than the input voltage Vin by the dead zone width ΔVa2 is output as the output voltage Vout₁ after discharge. Furthermore, when the data D(k−1) is “0” and the data D(k−2) to D0 is “0 . . . 0”, a voltage lower than the input voltage Vin by the dead zone width ΔVa3 is output as the output voltage Vout₁ after discharge.

Therefore, if k is 2 and the input voltage Vin is a gray scale voltage V8S, “11” and “10” represented by the data D1 and D0 determine the dead zone width, and the dead zone width allows gray scale voltages V8 and V9 as the output voltage Vout₁. In addition, the dead zone width determined based on “01” and “00” by the data D1 and D0 allows the output voltage Vout₁ corresponding to gray scale voltages V10 and V11.

In the above description for FIGS. 12 and 13, the number of the first and second current adjustment transistors is (k−1). However, the number is not limited thereto in the first configuration example.

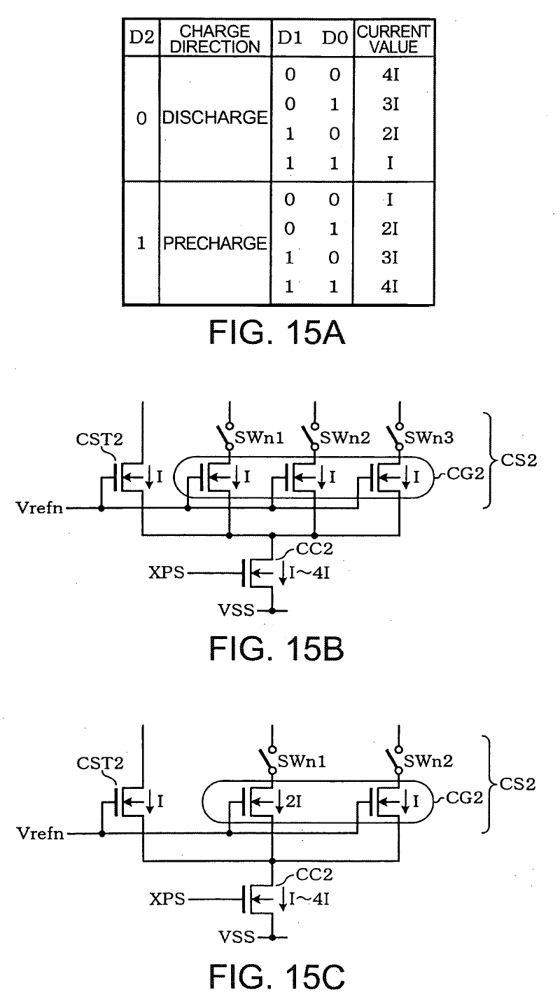

FIGS. 15A, 15B and 15C are explanatory diagrams relating to the number of the first and second current adjustment transistors.

FIG. 15A illustrates an example of current values of the first and second current sources CS1 and CS2 determining the dead zone width that corresponds to the data D1 and D0 of low two bits of the gray scale data when k is 3. For simplification, it is assumed that the current values of the first and second current sources CS1 and CS2 take values from I to 4I in accordance with the data D1 and D0.

FIG. 15B illustrates one configuration example of the second current source CS2 including the second current source transistor CST2 and the second current adjustment transistors CG2. The same description is also applied to the first current source CS1. Referring to FIG. 15B, the second current adjustment transistors CG2 are made up of three transistors each having the same current driving capability as that of the second current transistor CST2. Thus, controlling switch elements SWn1 to SWn3 with control signals allows a drain current having any one of current values I, 2I, 3I and 4I to be fed to the transistor CC2 in an on state.

FIG. 15C illustrates another configuration example of the second current source CS2 including the second current source transistor CST2 and the second current adjustment transistors CG2. The same description is also applied to the first current source CS1. Referring to FIG. 15C, the second current adjustment transistors CG2 are made up of two transistors. In contrast to FIG. 15B, the second current adjustment transistors CG2 are made up of two kinds of transistors: one has the same current driving capability as that of the second current source transistor CST2, and the other has the current driving capability twice that of the second current source transistor CST2. Also in this case, controlling switch elements SWn1 and SWn2 with control signals allows a drain current having any one of current values I, 2I, 3I and 4I to be fed to the transistor CC2 in an on state.

Thus, either configurations of FIGS. 15B and 15C can vary the dead zone width corresponding to the data D1 and D0 as shown in FIG. 15A. The first configuration example therefore is not limited to the number of the first and second current adjustment transistors.

A specific explanation of the impedance conversion circuit IPC₁ of the first configuration example will be made below as to the case in which j is 4 and k is 2.

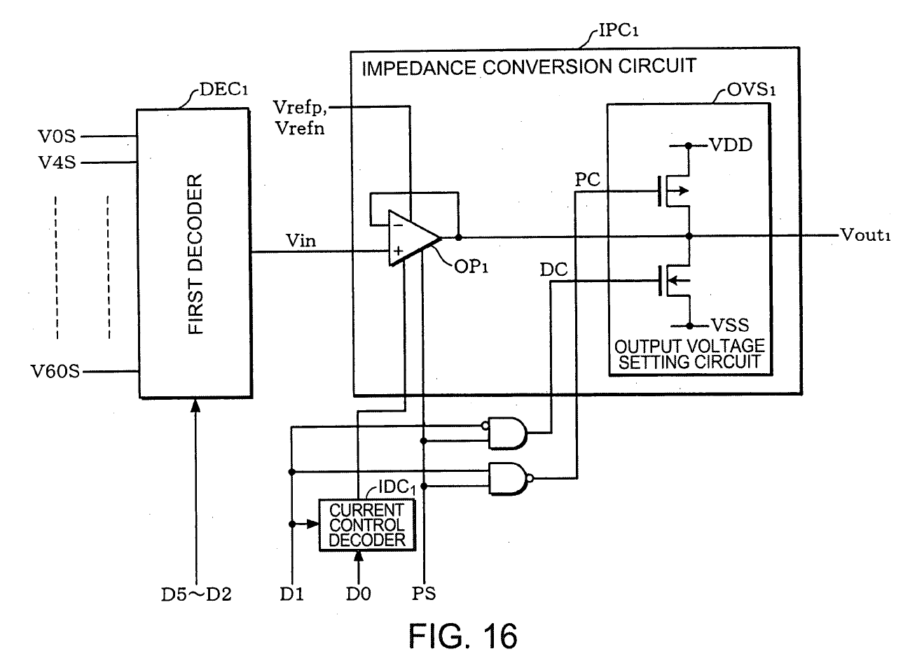

FIG. 16 is a block diagram showing the schematic configuration of an impedance conversion circuit of the first configuration example in the case in which j is 4 and k is 2. The same parts of FIG. 16 as those in FIG. 9 are given the same reference numerals and explanations therefor will be omitted appropriately.

In FIG. 16, the first decoder DEC₁ selects any one of 16 (=2⁴) levels of gray scale voltages V0S, V4S, . . . , V56S, V60S based on the data of high four bits of the gray scale data, and then outputs the voltage as the input voltage Vin of the impedance conversion circuit IPC₁. Subsequently, the impedance conversion circuit IPC₁ outputs, among 2² levels of voltages obtained by shifting the potential of the input voltage Vin, the voltage corresponding to the data D1 and D0 of low two bits of the gray scale data as the output voltage Vout₁.

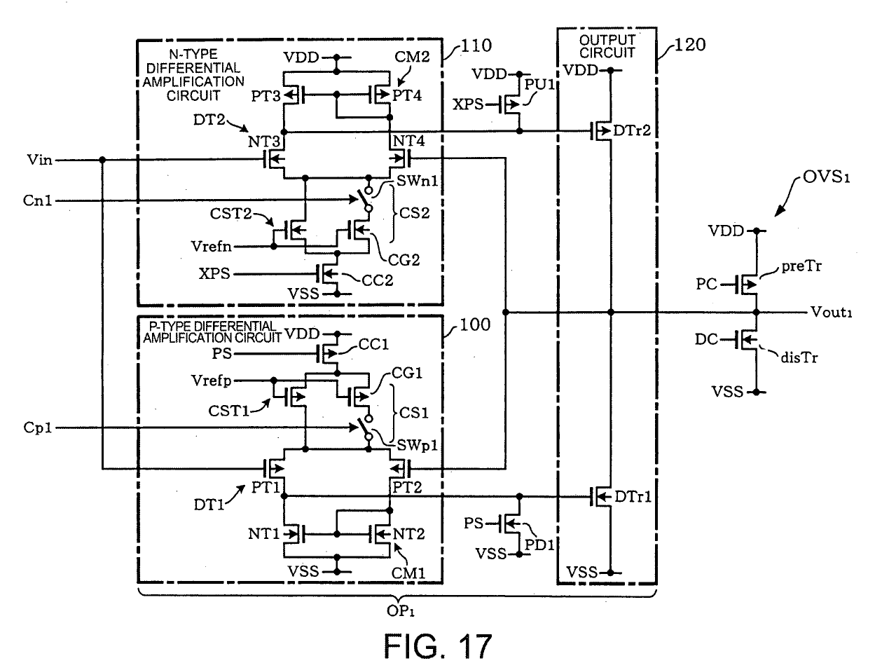

FIG. 17 is a circuit diagram of a configuration example of the operational amplifier OP₁ of FIG. 16. FIG. 17 also illustrates the configuration of the output setting circuit OVS₁ in addition to that of the operational amplifier OP₁. The same parts of FIG. 17 as those in FIGS. 12 and 16 are given the same reference numerals and explanations therefor will be omitted appropriately.

Since k is 2, the numbers of the first and second current adjustment transistors CG1 and CG2 are each 1 in FIG. 17. The switch elements SWp1 and SWn1 are turned on and off based on control signals Cp1 and Cn1. More specifically, in accordance with the truth table of FIG. 13, if the output is discharged (the data D1 is “0”) and the data D0 is “0”, the switch elements SWp1 and SWn1 are turned on so that the current values of the first and second current sources CS1 and CS2 become larger compared with the case in which the data D0 is “1”. In contrast, if the output is precharged (the data D1 is “1”) and the data D0 is “1”, the switch elements SWp1 and SWn1 are turned on so that the current values of the first and second current sources CS1 and CS2 become larger compared with the case in which the data D0 is “0”.

Such variation of current values from current sources can change the dead zone width. An explanation will be made below as to the dead zone width.

The operational amplifier connected as a voltage follower includes the differential transistor pair as described above. When designing such an operational amplifier, both transistors of the differential transistor pair are typically designed to have substantially the same current driving capability. This is because it is necessary to eliminate the dead zone of output of the operational amplifier to equalize the input and output voltages for achieving an impedance converter.

With taking an example the configuration of FIG. 17, the operation of a typical design example will be described. In the typical design example of the p-type differential amplification circuit 100 shown in FIG. 17, the transistors PT1 and PT2 have the same current driving capability. In the typical design example of the n-type differential amplification circuit 110 shown in FIG. 17, the transistors NT3 and NT4 have the same current driving capability.

When the input voltage Vin drops, the output voltage Vout₁ also drops, and when the input voltage Vin rises, the output voltage Vout₁ also rises. Equalizing the current driving capabilities of the transistors PT1 and PT2 allows control to equalize the gate voltages of the both transistors, thus equalizing the input voltage Vin and the output voltage Vout₁. In addition, equalizing the current driving capabilities of the transistors NT3 and NT4 allows control to equalize the gate voltages of the both transistors, thus equalizing the input voltage Vin and the output voltage Vout₁.

On the contrary, in the first configuration example, the current driving capacities of the both transistors of the first differential transistor pair DT1 are made different, while the current driving capacities of the both transistors of the second differential transistor pair DT2 are also made different.

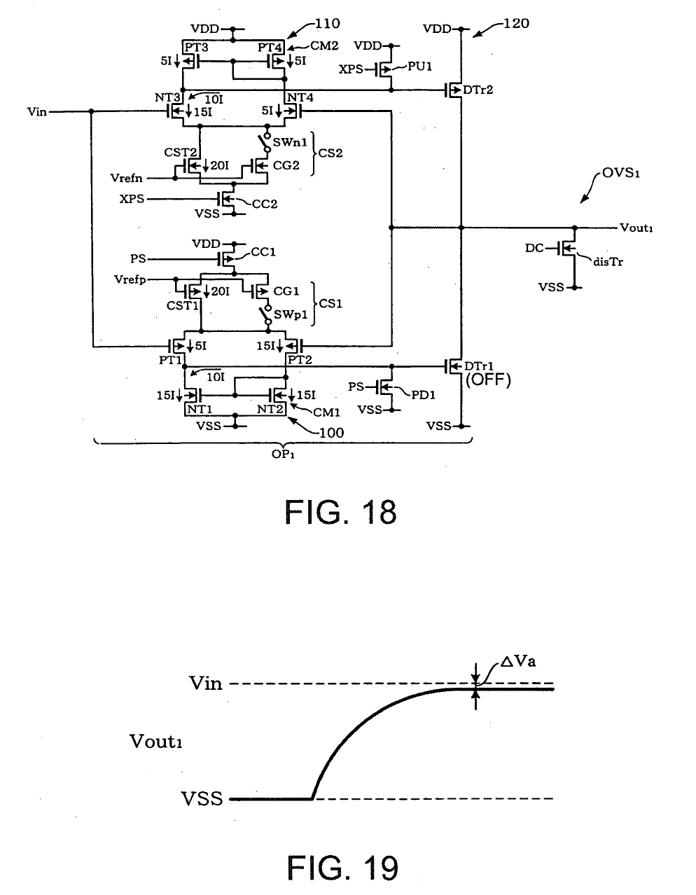

The operation of the operational amplifier OP₁ when an output is discharged will be described with reference to FIGS. 18 and 19.

FIG. 18 schematically shows the configuration of the operational amplifier OP₁ and the output voltage setting circuit OVS₁ of FIG. 17 when an output is discharged. The same parts as those in FIG. 17 are given the same reference numerals and explanations therefor will be omitted appropriately.

FIG. 19 shows an example of an operational waveform of the output voltage Vout₁ from the operational amplifier OP₁ of FIG. 17 when an output is discharged.

First, an explanation will be made as to the case in which the switch elements SWp1 and SWn1 are in an off state. In the p-type differential amplification circuit 100 of FIG. 18, the current driving capability of the transistor PT1 is lower than that of the transistor PT2. The amounts of currents to the transistors are determined by the first current source CS1. It is assumed that when the current value of the first current source CS1 is 20I, the drain current of the transistor PT1 is 8I while the drain current of the transistor PT2 is 12I in the equilibrium state.

In the n-type differential amplification circuit 110 of FIG. 18, the current driving capacity of the transistor NT3 is lower than that of the transistor NT4. The amounts of currents to the transistors are determined by the second current source CS2. It is assumed that when the current value of the second current source CS2 is 20I, the drain current of the transistor NT3 is 8I while the drain current of the transistor NT4 is 12I in the equilibrium state.

Here, it is assumed that the output voltage Vout₁ is set to the system ground supply voltage VSS in accordance with the discharge control signal DC. In this case, in the p-type differential amplification circuit 100, the drain current of the transistor PT2 increases to 15I, for example, while the drain current of the transistor PT1 becomes 5I. In the first current mirror circuit CM1, the drain currents of the transistors NT1 and NT2 have the same value (15I), which induces 10I of a current to be extracted from the gate of the first drive transistor Dtr1 to keep the equilibrium state. Therefore, the gate voltage of the first drive transistor Dtr1 drops, and thus the first drive transistor Dtr1 is controlled toward an off state (controlled to decrease the drain current).

In the n-type differential amplification circuit 110, the drain current of the transistor NT4 decreases to 5I, while the drain current of the transistor NT3 becomes 15I, for example. In the second current mirror circuit CM2, the drain currents of the transistors PT3 and PT4 have the same value (5I), which induces 10I of a current to be extracted from the gate of the second drive transistor Dtr2 to keep the equilibrium state. Therefore, the gate voltage of the second drive transistor Dtr2 drops, and thus the second drive transistor Dtr2 is controlled toward an on state (controlled to increase the drain current).

In this case, a state in which the drain currents of the transistors NT3 and NT4 are the same is stabilized due to the second current mirror circuit CM2. The transistors NT3 and NT4 are both an n-type MOS transistor, and the current driving capability of the transistor NT3 is lower than that of the transistor NT4. Therefore, a state stabilizes in which the input voltage Vin, which is the gate voltage of the transistor NT3, is higher than the output voltage Vout₁, which is the gate voltage of the transistor NT4. The difference between the input voltage Vin and the output voltage Vout₁ corresponds to the dead zone ΔVa. Therefore, if the input voltage Vin is defined as, for example, the gray scale voltage V0S as shown in FIG. 6, the output voltage Vout₁ can be output as the gray scale voltage V1.

If the switch element SWn1 is turned on, and thus the current of the second current source CS2 becomes 40I, the drain currents of the transistors NT3 and NT4 become 30I and 10I, respectively. The second current mirror circuit CM2 stabilizes a state in which the drain currents of the transistors NT3 and NT4 have the same value (10I), with the result that a state stabilizes in which the input voltage Vin, which is the gate voltage of the transistor NT3, is higher than the output voltage Vout₁, which is the gate voltage of the transistor NT4. At this time, the difference between the gate voltages for allowing the transistors NT3 and NT4 to be supplied with the same drain current (10I) is larger compared with the case in which the current of the second current source CS2 is 20I. Thus, the dead zone width ΔVa becomes larger. That is, a larger current of the second current source CS2 can provide a larger dead zone width ΔVa, while a smaller current of the second current source CS2 can provide a smaller dead zone width ΔVa.

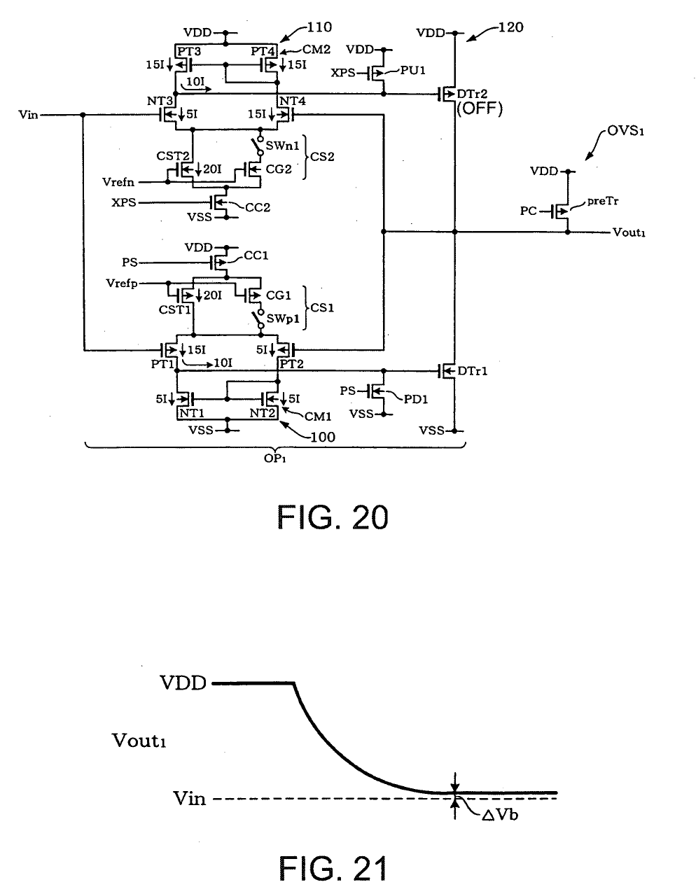

The operation of the operational amplifier OP₁ when an output is precharged will be described with reference to FIGS. 20 and 21.

FIG. 20 schematically shows the configuration of the operational amplifier OP₁ and the output voltage setting circuit OVS₁ of FIG. 17 when an output is precharge. The same parts as those in FIG. 17 are given the same reference numerals and explanations therefor will be omitted appropriately.

FIG. 21 shows an example of an operational waveform of the output voltage Vout₁ from the operational amplifier OP₁ of FIG. 17 when an output is precharged.

First, an explanation will be made as to the case in which the switch elements SWp1 and SWn1 are in an off state. In FIG. 20, it is assumed that the output voltage Vout₁ is set to the system supply voltage VDD in accordance with the precharge control signal PC. In this case, in the n-type differential amplification circuit 110, the drain current of the transistor NT4 increases to 15I, while the drain current of the transistor NT3 becomes 5I, for example. In the second current mirror circuit CM2, the drain currents of the transistors PT3 and PT4 have the same value (15I), which induces 10I of a current to be flowed into the gate of the second drive transistor Dtr2 to keep the equilibrium state. Therefore, the gate voltage of the second drive transistor Dtr2 rises, and thus the second drive transistor Dtr2 is controlled toward an off state.

Meanwhile, in the p-type differential amplification circuit 100, the drain current of the transistor PT2 decreases to 5I, for example, while the drain current of the transistor PT1 becomes 15I. In the first current mirror circuit CM1, the drain currents of the transistors NT1 and NT2 have the same value (5I), which induces 10I of a current to be flowed into the gate of the first drive transistor Dtr1 to keep the equilibrium state. Therefore, the gate voltage of the first drive transistor Dtr1 rises, and thus the first drive transistor Dtr1 is controlled toward an on state.

In this case, a state in which the drain currents of the transistors PT1 and PT2 are the same is stabilized due to the first current mirror circuit CM1. The transistors PT1 and PT2 are both a p-type MOS transistor, and the current driving capability of the transistor PT1 is lower than that of the transistor PT2. Therefore, a state stabilizes in which the input voltage Vin, which is the gate voltage of the transistor PT1, is lower than the output voltage Vout₁, which is the gate voltage of the transistor PT2. The difference between the input voltage Vin and the output voltage Vout₁ corresponds to the dead zone ΔVb. Therefore, if the input voltage Vin is defined as, for example, the gray scale voltage V0S as shown in FIG. 6, the output voltage Vout₁ can be output as the gray scale voltage V0.

If the switch element SWp1 is turned on, and thus the current of the first current source CS1 becomes 40I, the drain currents of the transistors PT1 and PT2 become 30I and 10I, respectively. The first current mirror circuit CM1 stabilizes a state in which the drain currents of the transistors PT1 and PT2 have the same value (10I), with the result that a state stabilizes in which the input voltage Vin, which is the gate voltage of the transistor PT1, is lower than the output voltage Vout1, which is the gate voltage of the transistor PT2. At this time, the difference between the gate voltages for allowing the transistors PT1 and PT2 to be supplied with the same drain current (10I) is larger compared with the case in which the current of the first current source CS1 is 10I. Thus, the dead zone width ΔVb becomes larger. That is, a larger current of the first current source CS1 can provide a larger dead zone width ΔVb, while a smaller current of the first current source CS1 can provide a smaller dead zone width ΔVb.

As described above, typical operational amplifiers are designed to have no dead zone of the output. However, in the impedance conversion circuit of the first configuration example, a voltage selected from 2^{j} levels of voltages based on the data of high j bits of the gray scale data is supplied to the input of the operational amplifier connected as a voltage follower as an input voltage. The output of the operational amplifier is precharged or discharged in accordance with the data of the most significant bit of low k bits of the gray scale data. Subsequently, the operational amplifier outputs a voltage different from the input voltage by the dead zone width of the operational amplifier. As described above, the impedance conversion circuit of the first configuration example can output 2^{k} levels of output voltages for a single input voltage by positively utilizing the dead zone. Using such an impedance conversion circuit as an impedance converter of a data driver can reduce the number of gray scale voltages generated by the reference voltage generating circuit 527 to one 2^{k}-th.

Note that “dead zone” described above is different from typical “input-output offset” of an operational amplifier in the following respects. “Input-output offset” is generated due to fluctuation in the thresholds of transistors and improper sizing between drive transistors of an output circuit and transistors of current mirror circuits. Therefore, even if the “input-output offset” exists, the voltage to be achieved from the precharge voltage and the voltage to be achieved from the discharge voltage are the same. On the contrary, “dead zone” described above is attributed to the difference of the current driving capabilities of transistors of differential transistor pairs. Therefore, the voltage to be achieved from the precharge voltage and the voltage to be achieved from the discharge voltage are different.

The first configuration example is not limited to the above description in which the current values of the first and second current sources CS1 and CS2 are varied based on values represented by the data D(k−2) to D0 in both cases of precharge and discharge. For example, since the operation of the p-type differential amplification circuit 100 has no effect on the output circuit 120 when the output is discharged while the operation of the n-type differential amplification circuit 110 has no effect on the output circuit 120 when the output is precharged, the current values of the first and second current sources CS1 and CS2 can be controlled as follows.

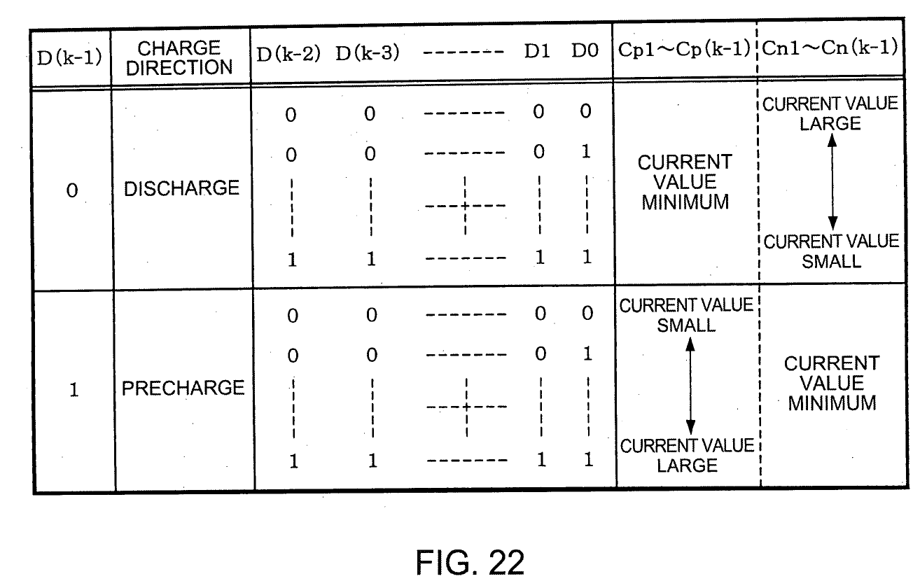

FIG. 22 illustrates an example of a truth table relating to the current control decoder IDC₁ for implementing another control of the current values of the first and second current sources CS1 and CS2.

Specifically, when the output is discharged, the control signals Cp1 to Cp(k−1) are generated so that the operating current of the first current source CS1 of the p-type differential amplification circuit 100 is stopped or limited to minimize (or reduce to 0) the current value of the first current source CS1. The control signals Cn1 to Cn(k−1) are generated similarly with FIG. 13.

When the output is precharged, the control signals Cn1 to Cn(k−1) are generated so that the operating current of the second current source CS2 of the n-type differential amplification circuit 110 is stopped or limited to minimize (or reduce to 0) the current value of the second current source CS2. The control signals Cp1 to Cp(k−1) are generated similarly with FIG. 13.

More specifically, the current value of the second current source CS2 is decreased when the current value of the first current source CS1 is increased, while the current value of the first current source CS1 is decreased when the current value of the second current source CS2 is increased. This operation not only achieves the same advantages as those of the first configuration example but also allows reduction of power consumption of the differential amplification circuit that has no effect on the output, permitting lower power consumption.

2.2 Second Configuration Example

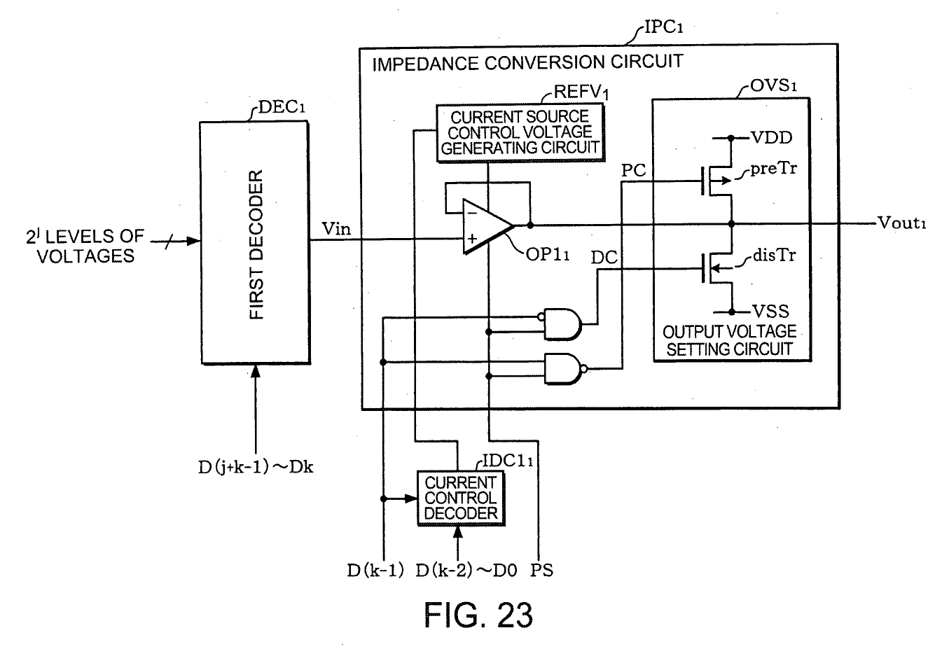

FIG. 23 is a block diagram showing the schematic configuration of an impedance conversion circuit of a second configuration example of the present embodiment. The same parts as those in FIG. 9 are given the same reference numerals and explanations therefor will be omitted appropriately. Although FIG. 23 illustrates an configuration example of only the impedance conversion circuit IPC₁, configurations of other impedance conversion circuits IPC₂ to IPC_{N} are the same.

The impedance conversion circuit IPC₁ of the second configuration example includes an operational amplifier OP1₁ connected as a voltage follower, the output voltage setting circuit OVS₁, and a current source control voltage generating circuit REFV₁. The input of the operational amplifier OP1₁ is supplied with the input voltage Vin. The dead zone width of the output of the operational amplifier OP1₁ is determined based on the data of low (k−1) bits of low k bits of the gray scale data.

The output voltage setting circuit OVS₁ precharges or discharges the output of the operational amplifier OP1₁ in accordance with the data of the most significant bit of low k bits of the gray scale data. For example, if k is 2 for example, precharge or discharge is executed based on the data D1, which is the data of the most significant bit of low two bits of the gray scale data.

The operational amplifier OP1₁ stops driving of the output, and then the output voltage setting circuit OVS₁ precharges or discharges the output of the operational amplifier OP1₁. Thereafter, the operational amplifier OP1₁ starts driving of the output to output the voltage shifted from the input voltage Vin by the dead zone width of the operational amplifier OP1₁ as the output voltage. As described above, the operation of the second configuration example is the same as that of the first configuration example.

The second configuration example is different from the first configuration example in that the impedance conversion circuit IPC₁ includes the current source control voltage generating circuit REFV₁. The generating circuit REFV₁ generates a control voltage to control the current value of the current source that generates the operating current of the operational amplifier OP1₁. Specifically, the generating circuit REFV₁ supplies the gate of a p-type MOS transistor as a first current source transistor of the first current source CS1 with a voltage that is varied based on the data D(k−1) to D0 of low k bits of the gray scale data, and can thereby vary the current of the first current source CS1. Furthermore, the generating circuit REFV1 supplies the gate of an n-type MOS transistor as a second current source transistor of the second current source CS2 with a voltage that is varied based on the data D(k−1) to D0 of low k bits of the gray scale data, and can thereby vary the current of the second current source CS2. Both the first and second current sources may be controlled simultaneously, or either one of the first and second current sources may be controlled.

The current source control voltage generating circuit REFV₁ generates a control voltage based on control signals generated by a current control decoder IDC1₁. The current control decoder IDC1₁ generates the control signals based on the data D(k−1) to D0 of low k bits of the gray scale data. The current control decoder IDC1₁ is provided inside or outside the impedance conversion circuit IPC₁.

In the second configuration example, the current source control voltage generating circuit REFV₁ generates control voltages for current sources as described above. Thus, each gray scale voltage can be generated more highly accurately compared with the first configuration example even if variation of the transistors exists.

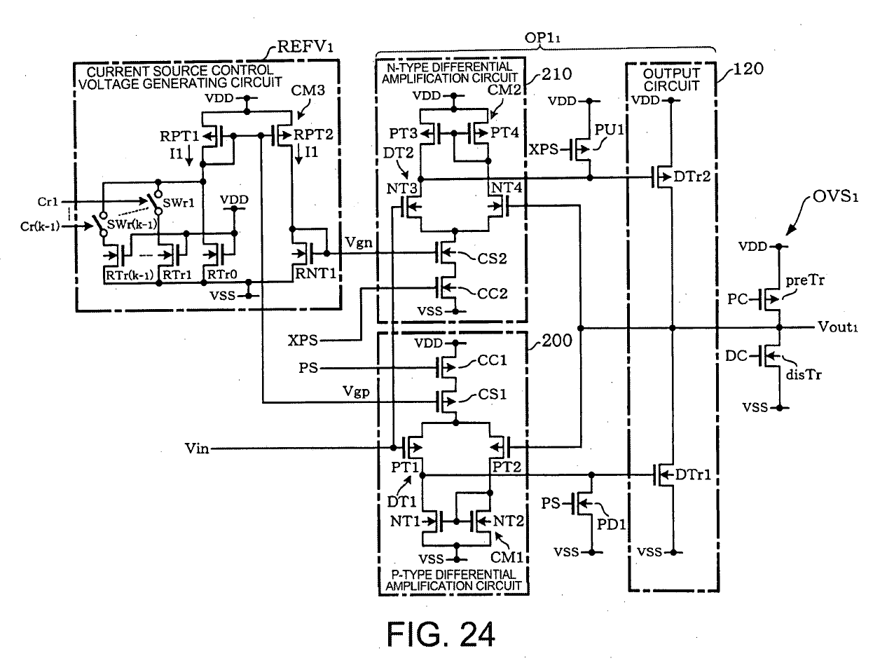

FIG. 24 is a circuit diagram of a configuration example of the operational amplifier OP1₁ according to the second configuration example of the present embodiment. In FIG. 24, the configurations of the output setting circuit OVS₁ and the current source control voltage generating circuit REFV₁ are illustrated in addition to the operational amplifier OP₁. The same parts of FIG. 24 as those in FIG. 12 are given the same reference numerals and explanations therefor will be omitted appropriately.

The operational amplifier OP1₁ includes a p-type (a first conductivity type) differential amplification circuit 200, an n-type (a second conductivity type) differential amplification circuit 210, and the output circuit 120. Since the output circuit 120 is the same as that in the first configuration example, the description therefor will be omitted.

The configuration of the first current source CS1 differentiates the p-type differential amplification circuit 200 from the p-type differential amplification circuit 100 of the first configuration example. Other features are the same as those of the first configuration example, and therefore will not be described. The first current source CS1 of the p-type differential amplification circuit 200 is made up of a p-type MOS transistor. The gate voltage Vgp of the transistor is supplied from the current source control voltage generating circuit REFV₁.

The configuration of the second current source CS2 differentiates the n-type differential amplification circuit 210 from the n-type differential amplification circuit 110 of the first configuration example. Other features are the same as those of the first configuration example, and therefore will not be described. The second current source CS2 of the n-type differential amplification circuit 210 is made up of an n-type MOS transistor. The gate voltage Vgn of the transistor is supplied from the current source control voltage generating circuit REFV₁.

The current source control voltage generating circuit REFV₁ includes a reference current source transistor RTr0. The reference current source transistor RTr0 is made up of an n-type MOS transistor. The gate of the transistor is supplied with the system supply voltage VDD. The current source control voltage generating circuit REFV₁ has a current mirror configuration, and thus generates the gate voltages Vgp and Vgn of the transistors of the first and second current sources CS1 and CS2 so that the currents to the transistors of the first and second current sources are the same as the drain current of the reference current source transistor RTr0, for example.

More specifically, the current source control voltage generating circuit REFV₁ includes a third current mirror circuit CM3. The third current mirror circuit CM3 is made up of p-type MOS transistors RPT1 and RPT2. The sources of the transistors RPT1 and RPT2 are supplied with the system supply voltage VDD, and the gates of the transistors are coupled to each other. The gate and drain of the transistor RPT1 are coupled to each other.

The drain of the transistor RPT1 is coupled to the drain of the transistor RTr0. The source of the transistor RTr0 is supplied with the system ground supply voltage VSS.

The current source control voltage generating circuit REFV₁ further includes an n-type MOS transistor RNT1. The drain of the transistor RNT1 is coupled to the drain of the transistor RPT2. The gate and drain of the transistor RNT1 are coupled to each other. The source of the transistor RNT1 is supplied with the system ground supply voltage VSS.

Furthermore, the current source control voltage generating circuit REFV₁ includes one or more reference current adjustment transistors RTr1 to RTr(k−1). One or more reference current adjustment transistors RTr1 to RTr(k−1) are each an n-type MOS transistor. The sources of the transistors RTr1 to RTr(k−1) are supplied with the system ground supply voltage VSS. Each transistor is coupled via a switch element to the drain of the transistor RPT1. The switch elements are turned on and off in accordance with control signals Cr1 to Cr(k−1). Specifically, the drain current of the transistor RTr0 is changed based on the control signals Cr1 to Cr(k−1), with the result that the drain current of the transistor RPT1 is changed.

In the current source control voltage generating circuit REFV₁ having such a configuration, the gate of the transistor RPT1 is coupled to the gate of the transistor of the first current source CS1 of the p-type differential amplification circuit 200. The gate of the transistor RNT1 is coupled to the gate of the transistor of the second current source CS2 of the n-type differential amplification circuit 210.

If a current I1 attributed to the transistor RTr0 and any of the transistors RTr1 to RTr(k−1) coupled to a turned-on switch element is generated, the drain current of the transistor RPT2 also becomes I1 due to the third current mirror circuit CM3.

The transistor RPT1 and the transistor of the first current source CS1 form a current mirror circuit. The transistor RNT1 and the transistor of the second current source CS2 also form a current mirror circuit similarly. Therefore, the current source control voltage generating circuit REFV₁ can generate such gate voltage Vgp that the current of the first current source CS1 becomes the same as the drain current of the transistor RPT1. In addition, the generating circuit REFV₁ can generate such gate voltage Vgn that the current of the second current source CS2 becomes the same as the drain current of the transistor RNT1.

Since the drain current of the transistor RPT1 can be varied in accordance with the control signals Cr1 to Cr(k−1), the current values of the first and second current sources CS1 and CS2 can be controlled based on the control signals Cr1 to Cr(k−1).

Although FIG. 24 shows the case in which the gates of the transistors RTr0 and RTr1 to RTr(k−1) are supplied with the system supply voltage VDD, a certain voltage other than the system supply voltage VDD may be supplied to the gates. Supply of the system supply voltage VDD to the gates, however, can suppress variation of currents of the transistors more effectively.

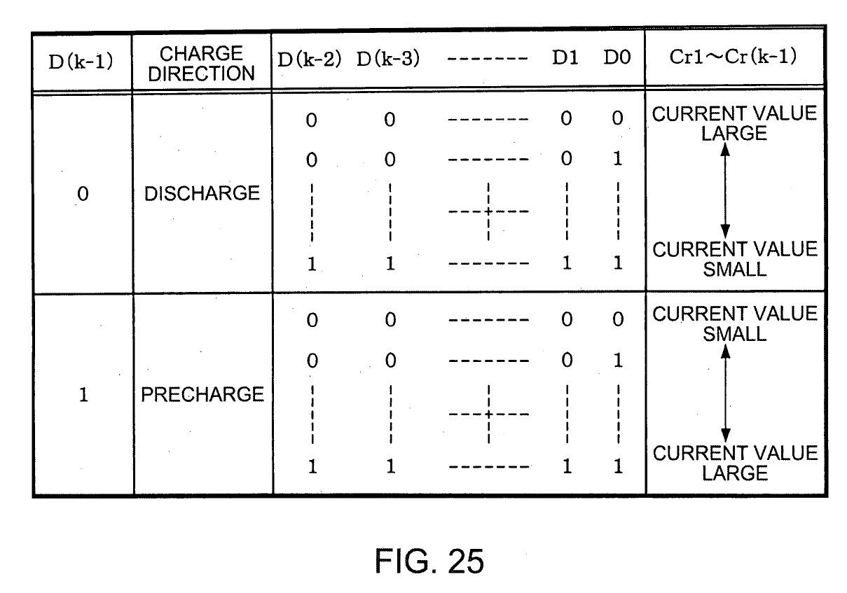

FIG. 25 shows an example of a truth table for illustrating the operation of the current control decoder IDC1₁ of FIG. 23.

The current control decoder IDC1₁, similarly with FIG. 13, generates such control signals Cr1 to Cr(k−1) that the current values of the first and second current sources CS1 and CS2 become smaller as values represented by the data D(k−2) to D0 become larger from “00 . . . 00” to “11 . . . 11”.

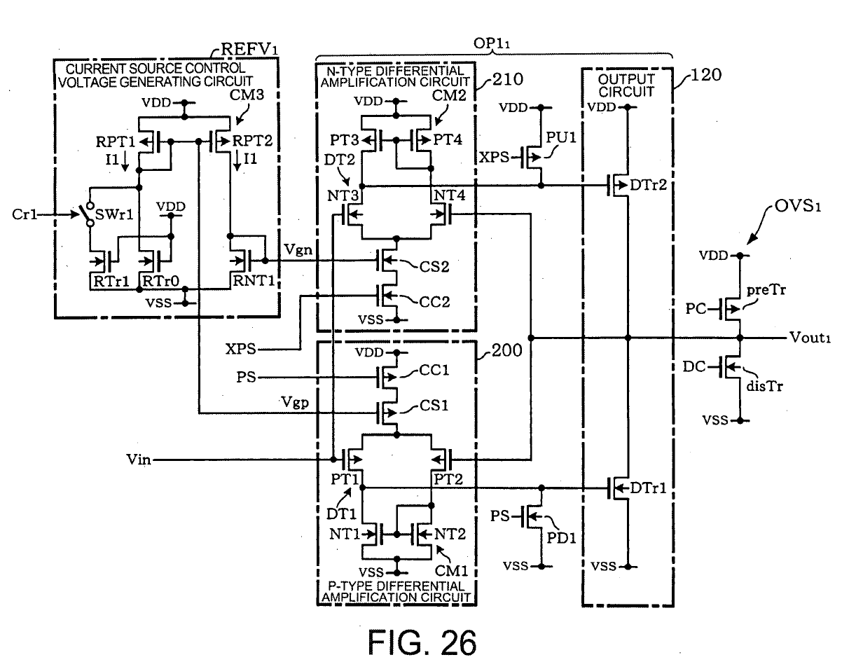

FIG. 26 is a block diagram showing the schematic configuration of the impedance conversion circuit IPC1₁ of the second configuration example in the case in which k is 2. The same parts of FIG. 26 as those in FIG. 24 are given the same reference numerals and explanations therefor will be omitted appropriately.

If k is 2, a transistor that can be coupled to the transistor RTr0 in parallel is only the transistor RTr1, and the transistor RTr1 is turned on and off by the control signal Cr1.

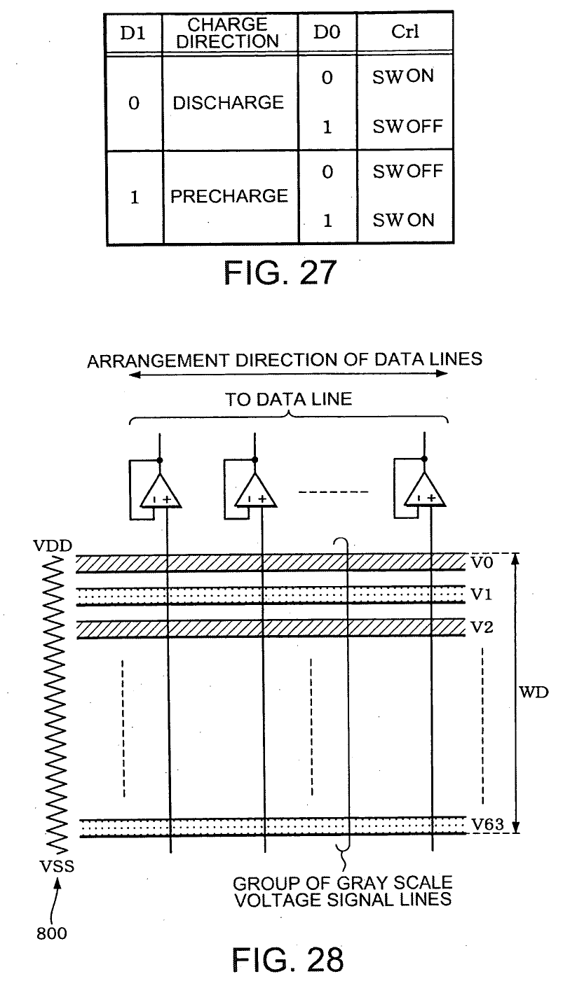

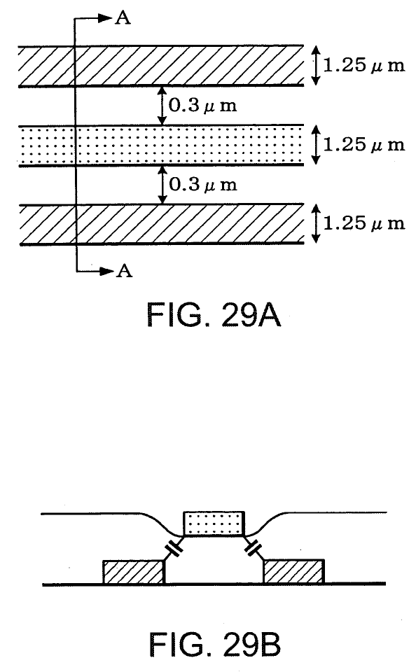

FIG. 27 shows an example of a truth table for illustrating the operation of the current control decoder IDC1₁ in the case in which k is 2.

If k is 2, the data D1 and D0 of low two bits of the gray scale data is input to the current control decoder IDC1₁.

If the data D1 is “0”, since the output voltage setting circuit OVS₁ discharges the output of the operational amplifier OP1₁, the control signal Cr1 is generated so that the switch element SWr1 is turned on when the data D0 is “0” while the switch element SWr1 is turned off when the data D0 is “1”.

If the data D1 is “1”, since the output voltage setting circuit OVS₁ precharges the output of the operational amplifier OP1₁, the control signal Cr1 is generated so that the switch element SWr1 is turned off when the data D0 is “0” while the switch element SWr1 is turned on when the data D0 is “1”.

Turning on the switch element SWr1 can increase the drain current of the transistor RPT1, resulting in a larger dead zone width. In contrast, turning off the switch element SWr1 can provide a smaller dead zone width compared with the case of turning on the switch element SWr1.

The second configuration is not also limited to the number of transistors RTr1 to RTr(k−1). Similarly with the description for FIGS. 15A to 15C as to the first configuration example, the number of transistors can be changed by adjusting the current driving capability of each transistor.

Also in the second configuration example, lower power consumption can be achieved by decreasing the current value of the first current source CS1 when the output is discharged while decreasing the current value of the second current source CS2 when the output is precharged, similarly with the description for FIG. 22 as to the first configuration example. This current control can be achieved by, for example, controlling the gate voltages of the transistors RNT1 and RPT1 with using the data D(k−1) of the most significant bit of low k bits of the gray scale data, or directly controlling the transistors CC1 and CC2 to stop or limit the current of first or second current source CS1 or CS2.

It should be noted that the invention is not limited to the above-described embodiment but can variously be modified within the scope and the spirit of the invention. For example, the invention is not limited to those applied for driving liquid crystal panels as described above, but can also be applied for driving electroluminescence and plasma display devices.

Part of requirements of any claim of the invention could be omitted from a dependent claim which depends on that claim. Moreover, part of requirements of any independent claim of the invention could be made to depend on any other independent claim.

Although only some embodiments of the invention have been described in detail above, those skilled in the art will readily appreciate that many modifications are possible in the embodiments without departing from the novel teachings and advantages of this invention. Accordingly, all such modifications are intended to be included within the scope of this invention.

What is claimed is:

1. An impedance conversion circuit for outputting a voltage corresponding to (j+k) (j is a positive integer, k is a positive integer more than 1) bits of gray scale data, the impedance conversion circuit comprising:
an operational amplifier connected as a voltage follower and supplied with, as an input voltage, a voltage selected from 2^{j} levels of voltages based on data of high j bits of the gray scale data; and
an output voltage setting circuit for precharging or discharging an output of the operational amplifier based on data of a most significant bit of low k bits of the gray scale data,
wherein the operational amplifier outputs, as an output voltage, a voltage having a difference from the input voltage by a dead zone width after the output voltage setting circuit precharges or discharges the output of the operational amplifier; and
wherein the dead zone width is determined by an operating current of the operational amplifier, the operating current being varied based on data of the low k bits of the gray scale data.

2. The impedance conversion circuit according to claim 1,
wherein the operational amplifier includes:
a first-conductivity-type differential amplification circuit having a first differential transistor pair of a first conductivity type and a first current mirror circuit, the first differential transistor pair having a first input-side transistor and a first output-side transistor, a source of each of the first input-side and first output-side transistors being supplied with a current from a first current source, a gate of the first input-side transistor being supplied with the input voltage, a gate of the first output-side transistor being supplied with the output voltage, and the first current mirror circuit generating a drain current of each of the first input-side and first output-side transistors;
a second-conductivity-type differential amplification circuit having a second differential transistor pair of a second conductivity type and a second current mirror circuit, the second differential transistor pair having a second input-side transistor and a second output-side transistor, a source of each of the second input-side and second output-side transistors being supplied with a current from a second current source, a gate of the second input-side transistor being supplied with the input voltage, a gate of the second output-side transistor being supplied with the output voltage, and the second current mirror circuit generating a drain current of each of the second input-side and second output-side transistors; and
an output circuit having a first drive transistor of the second conductivity type and a second drive transistor of the first conductivity type, a gate voltage of the first drive transistor being controlled based on a drain voltage of the first input-side transistor of the first differential transistor pair, a gate voltage of the second drive transistor being controlled based on a drain voltage of the second input-side transistor of the second differential transistor pair, drains of the first and second drive transistors being coupled to each other, and the output circuit outputting, as the output voltage, a voltage at a coupling node of the drains;
wherein a first input-side current driving capability of the first input-side transistor is lower than a first output-side current driving capability of the first output-side transistor;
wherein a second input-side current driving capability of the second input-side transistor is lower than a second output-side current driving capability of the second output-side transistor; and
wherein a current of at least one of the first and second current sources is controlled based on the data of the low k bits of the gray scale data to vary the dead zone width.

3. The impedance conversion circuit according to claim 2, further comprising the first current source,
wherein the first current source includes:
a first current source transistor coupled to the source of each of the first input-side and first output-side transistors of the first differential transistor pair of the first conductivity type, a gate of the first current source transistor being supplied with a first constant voltage; and
at least one first current adjustment transistor whose gate is supplied with the first constant voltage; and
wherein at least one source or at least one drain of the first current adjustment transistor is electrically coupled to or electrically isolated from a source or a drain of the first current source transistor based on the data of the low k bits of the gray scale data to vary a current of the first current source.

4. The impedance conversion circuit according to claim 2, further comprising the second current source,
wherein the second current source includes:
a second current source transistor coupled to the source of each of the second input-side and second output-side transistors of the second differential transistor pair of the second conductivity type, a gate of the second current source transistor being supplied with a second constant voltage; and
at least one second current adjustment transistor whose gate is supplied with the second constant voltage; and
wherein at least one source or at least one drain of the second current adjustment transistor is electrically coupled to or electrically isolated from a source or a drain of the second current source transistor based on the data of the low k bits of the gray scale data to vary a current of the second current source.

5. The impedance conversion circuit according to claim 2,
wherein, when a current of the first and second current sources is varied based on the data of the low k bits of the gray scale data, a current of the second current source is decreased when a current of the first current source is increased, while a current of the first current source is decreased when a current of the second current source is increased.

6. The impedance conversion circuit according to claim 2, further comprising:
the first current source that has a first current source transistor coupled to the source of each of the first input-side and first output-side transistors of the first differential transistor pair of the first conductivity type,
wherein a gate of the first current source transistor is supplied with a voltage that varies based on the data of the low k bits of the gray scale data to vary a current of the first current source.

7. The impedance conversion circuit according to claim 2, further comprising
the second current source that has a second current source transistor coupled to the source of each of the second input-side and second output-side transistors of the second differential transistor pair of the second conductivity type,
wherein a gate of the second current source transistor is supplied with a voltage that varies based on the data of the low k bits of the gray scale data to vary a current of the second current source.

8. The impedance conversion circuit according to claim 2, wherein:
the dead zone width is increased by increasing a current of at least one of the first and second current sources; and
the dead zone width is decreased by decreasing a current of at least one of the first and second current sources.

9. The impedance conversion circuit according to claim 1, wherein:
the output voltage setting circuit sets the output of the operational amplifier to a precharge voltage higher than the input voltage when the output is precharged; and
the output voltage setting circuit sets the output of the operational amplifier to a discharge voltage lower than the input voltage when the output is discharged.

10. A drive circuit for driving an electro-optical device having a plurality of scan lines, a plurality of data lines, and a plurality of pixel electrodes specified by the scan lines and the data lines, the drive circuit comprising:
a voltage selection circuit for outputting, as an input voltage, a voltage selected from 2^{j} levels of voltages based on data of high j bits of gray scale data; and
the impedance conversion circuit according to claim 1,
wherein the output voltage is supplied to any of the data lines.

11. A drive circuit for driving an electro-optical device having a plurality of scan lines, a plurality of data lines, and a plurality of pixel electrodes specified by the scan lines and the data lines, the drive circuit comprising:
a voltage selection circuit for outputting, as an input voltage, a voltage selected from 2^{j} levels of voltages based on data of high j bits of gray scale data;
the impedance conversion circuit according to claim 6; and
a current source control voltage generating circuit for generating a voltage that varies based on data of low k bits of the gray scale data,
wherein the current source control voltage generating circuit supplies a gate voltage of at least one of the first and second current source transistors.

12. A drive circuit for driving an electro-optical device having a plurality of scan lines, a plurality of data lines, and a plurality of pixel electrodes specified by the scan lines and the data lines, the drive circuit comprising:
a voltage selection circuit for outputting, as an input voltage, a voltage selected from 2^{j} levels of voltages based on data of high j bits of gray scale data;
the impedance conversion circuit according to claim 7; and
a current source control voltage generating circuit for generating a voltage that varies based on data of low k bits of the gray scale data,
wherein the current source control voltage generating circuit supplies a gate voltage of at least one of the first and second current source transistors.

13. The drive circuit according to claim 10, further comprising:
a reference voltage generating circuit for generating 2^{j} levels of voltages obtained by dividing a voltage between a first supply voltage and a second supply voltage.

14. The drive circuit according to claim 11, further comprising:
a reference voltage generating circuit for generating 2^{j} levels of voltages obtained by dividing a voltage between a first supply voltage and a second supply voltage.

15. A method for controlling an impedance conversion circuit for outputting a voltage corresponding to (j+k) (j is a positive integer, k is a positive integer more than 1) bits of gray scale data, the method comprising:
precharging or discharging an output of an operational amplifier connected as a voltage follower based on data of a most significant bit of low k bits of the gray scale data, an input of the operational amplifier being supplied with, as an input voltage, a voltage selected from 2^{j} levels of voltages based on data of high j bits of the gray scale data; and then
outputting, from the operational amplifier, a voltage having a difference from the input voltage by a dead zone width as an output voltage,
wherein the dead zone width is determined by an operating current of the operational amplifier, the operating current being varied based on data of the low k bits of the gray scale data.
